(19) United States
(12) Patent Application Publication
(10) Pub. No.: US 2021/0380474 A1
(43) Pub. Date: Dec. 9, 2021

(54) FLEXIBLE GLASS COVER WITH POLYMERIC COATINGS

(71) Applicant: CORNING INCORPORATED, CORNING, NY (US)

(72) Inventors: Charles Brandenburg, Wellsboro, PA (US); Claire Renata Coble, Horseheads, NY (US); Richard Allen Hayes, Beaumont, TX (US); Ying Zhang, Horseheads, NY (US)

(21) Appl. No.: 17/291,135

(22) PCT Filed: Oct. 21, 2019
(86) PCT No.: PCT/US2019/057204

§ 371 Date: May 4, 2021

Related U.S. Application Data
(60) Provisional application No. 62/758,028, filed on Nov. 9, 2018.

(51) Int. Cl. C03C 17/32; C03C 21/00

(52) U.S. Cl. CPC C03C 17/328; C03C 2218/365; C03C 21/002; C03C 17/322

(57) ABSTRACT

Glass articles having a glass layer with a top a top surface, a bottom surface, and a thickness in the range of 10 microns to 200 microns, and having: a top polymeric coating layer disposed on the top surface of the glass layer with a thickness in the range of 0.1 microns to 10 microns; and/or a bottom polymeric coating layer disposed on the bottom surface of the glass layer with a thickness in the range of 0.1 microns to 10 microns. The glass articles may achieve a bend radius of 10 mm or less. The glass articles may have a shatter resistance defined by the capability of the glass article to avoid ejection of glass shard particles from the glass article upon bending to a failure bend radius.

### CROSS-REFERENCE TO RELATED APPLICATION

This application claims the benefit of priority under 35 U.S.C. § 119 of U.S. Provisional Application Ser. No. 62/758028 filed on Nov. 9, 2018, the content of which is relied upon and incorporated herein by reference in its entirety.

BACKGROUND

### Field

The present disclosure relates to cover substrates including polymeric coatings. In particular, the present disclosure relates to flexible cover substrates including polymeric coatings.

### Background

A cover substrate for a display of an electronic device protects a display screen and provides an optically transparent surface through which a user can view the display screen. Recent advancements in electronic devices (e.g., handheld and wearable devices) are trending towards lighter devices with improved reliability. The weight of different components of these devices, including protective components, for example cover substrates, have been reduced to create lighter devices.

Also, consumer electronic industries have been focusing on turning wearable and/or flexible concepts into consumer products for years. Recently, thanks to continuous development and improvement of plastic films, plastic-based cover substrates for devices have demonstrated some success in the market. However, the intrinsic drawbacks of using plastic cover substrates remain, for example low moisture/oxidation resistibility and low surface hardness, which can lead to device failure during use. The use of a plastic substrate for its the flexibility, may in some situations, increase weight, reduce optical transparency, reduce scratch resistance, reduce puncture resistance, and/or reduce thermal durability for a cover substrate.

Therefore, a continuing need exists for innovations in cover substrates, for example cover substrates for protecting a display screen. And in particular, cover substrates for consumer devices including a flexible component, for example a flexible display screen.

### BRIEF SUMMARY

The present disclosure is directed to cover substrates, for example flexible cover substrates for protecting a flexible, foldable, or sharply curved component, for example a display component, including a polymeric coating layer that does not negatively affect the flexibility or curvature of the component while also protecting the component from damaging mechanical forces. The flexible cover substrate may include a flexible glass layer and a polymeric coating layer disposed on the flexible glass layer for providing impact and/or puncture resistance, as well as prevention or reduction of ejection of glass shard particles in the event that the glass layer fractures.

Some embodiments are directed to a glass article including a glass layer having a top surface, a bottom surface, and a thickness in the range of 10 microns to 200 microns, and at least one of: a top polymeric coating layer disposed on a top surface of the glass layer, where the top polymeric coating layer has a thickness in the range of 0.1 microns to 200 microns, or a bottom polymeric coating layer disposed on a bottom surface of the glass layer, where the bottom polymeric coating layer has a thickness in the range of 0.1 microns to 200 microns. The top polymeric coating layer and the bottom polymeric coating layer include an ethylene-acid copolymer, and the glass article achieves a bend radius of 10 mm or less.

Some embodiments are directed to a glass article including a glass layer having a top surface, a bottom surface, and a thickness in the range of 10 microns to 200 microns, and at least one of: a top polymeric coating layer disposed on a top surface of the glass layer, where the top polymeric coating layer has a thickness in the range of 0.1 microns to 200 microns, or a bottom polymeric coating layer disposed on a bottom surface of the glass layer, where the bottom polymeric coating layer has a thickness in the range of 0.1 microns to 200 microns. The top polymeric coating layer and the bottom polymeric coating layer include a solidified polyurethane dispersion, and the glass article achieves a bend radius of 10 mm or less.

Some embodiments are directed to a glass article including a glass layer having a top surface, a bottom surface, and a thickness in the range of 10 microns to 200 microns, and at least one of: a top polymeric coating layer disposed on a top surface of the glass layer, where the top polymeric coating layer has a thickness in the range of 0.1 microns to 200 microns, or a bottom polymeric coating layer disposed on a bottom surface of the glass layer, where the bottom polymeric coating layer has a thickness in the range of 0.1 microns to 200 microns. The top polymeric coating layer and the bottom polymeric coating layer include an acrylate resin, and the glass article achieves a bend radius of 10 mm or less.

Some embodiments are directed to a glass article including a glass layer having a top surface, a bottom surface, and a thickness in the range of 10 microns to 200 microns, and at least one of: a top polymeric coating layer disposed on a top surface of the glass layer, where the top polymeric coating layer has a thickness in the range of 0.1 microns to 200 microns, or a bottom polymeric coating layer disposed on a bottom surface of the glass layer, where the bottom polymeric coating layer has a thickness in the range of 0.1 microns to 200 microns. The top polymeric coating layer and the bottom polymeric coating layer include a mercapto-ester resin, and the glass article achieves a bend radius of 10 mm or less.

In some embodiments, the thickness of the top polymeric coating layer according to embodiments of any of the preceding paragraphs may be in the range of 0.1 microns to 10 microns.

In some embodiments, the thickness of the bottom polymeric coating layer according to embodiments of any of the preceding paragraphs, may be in the range of 0.1 microns to 10 microns.

In some embodiments, the thickness of the top polymeric coating layer, according to embodiments of any of the preceding paragraphs, may be in the range of 0.1 microns to 10 microns, and the thickness of the bottom polymeric coating layer, according to embodiments of any of the preceding paragraphs, may be in the range of 0.1 microns to 10 microns.

Some embodiments are directed to a glass article including a glass layer having a top surface, a bottom surface, and a thickness in the range of 10 microns to 200 microns, and at least one of: a top polymeric coating layer disposed on a top surface of the glass layer, where the top polymeric coating layer has a thickness in the range of 0.1 microns to 10 microns, or a bottom polymeric coating layer disposed on a bottom surface of the glass layer, where the bottom polymeric coating layer has a thickness in the range of 0.1 microns to 10 microns. Where the glass article achieves a bend radius of 10 mm or less, and a shatter resistance defined by the capability of the glass article to avoid ejection of glass shard particles having an average aspect ratio of more than 3:1 upon bending to a failure bend radius.

In some embodiments, the glass layer according to embodiments of any of the preceding paragraphs is an ion exchanged glass layer having a compressive stress on at least one of the top surface and the bottom surface of the glass layer, and a concentration of metal oxide that is different at at least two points through the thickness of the glass layer.

In some embodiments, the glass article according to embodiments of any of the preceding paragraphs includes the top polymeric coating layer.

In some embodiments, the glass article according to embodiments of any of the preceding paragraphs includes the bottom polymeric coating layer.

In some embodiments, the glass article according to embodiments of any of the preceding paragraphs may include both the top polymeric coating layer and the bottom polymeric coating layer.

In some embodiments, the glass article according to embodiments of any of the preceding paragraphs may have a shatter resistance defined by the capability of the glass article to avoid ejection of glass shard particles having an average aspect ratio of more than 2:1 upon bending of to a failure bend radius.

In some embodiments, the glass article according to embodiments of any of the preceding paragraphs may have a shatter resistance defined by the capability of the glass article of avoid ejection of glass shard particles having an average velocity of greater than 10×10³ mm/second upon bending to a failure bend radius.

In some embodiments, the glass article according to embodiments of any of the preceding paragraphs may have a shatter resistance defined by the capability of the glass article to avoid ejection of glass shard particles having an average velocity of greater than 1×10³ mm/second upon bending to a failure bend radius.

In some embodiments, the top polymeric coating layer and the bottom polymeric coating layer according to embodiments of any of the preceding paragraphs are solidified at a temperature of 170° C. or lower.

In some embodiments, the glass article according to embodiments of any of the preceding paragraphs may include a polymeric optically transparent hard-coat layer disposed on the top polymeric coating layer.

Some embodiments are directed to a glass article including a glass layer having a top surface, a bottom surface, a thickness in the range of 10 microns to 200 microns, a top polymeric coating layer disposed on the top surface of the glass layer, where the top polymeric coating layer has a thickness in the range of 0.1 microns to 10 microns, and a bottom polymeric coating layer disposed on the bottom surface of the glass layer, where the bottom polymeric coating layer has a thickness in the range of 0.1 microns to 10 microns. Where the glass article achieves a bend radius of 10 mm or less, an impact resistance defined by the capability of the glass article to avoid failure at an average pen drop height that is 2 times or more than that of a control pen drop height of the glass layer without the top and bottom polymeric coating layers, where the average pen drop height and the control pen drop height are measured according to a Pen Drop Test, and a shatter resistance defined by the capability of the glass article to avoid ejection of glass shard particles from the glass article upon bending to a failure bend radius.

Some embodiments are directed to a glass article including a glass layer comprising a top surface, a bottom surface, and a thickness in the range of 10 microns to 200 microns, a top polymeric coating layer disposed on the top surface of the glass layer, where the top polymeric coating layer has a thickness in the range of 0.1 microns to 10 microns, and a bottom polymeric coating layer disposed on the bottom surface of the glass layer, where the bottom polymeric coating layer has a thickness in the range of 0.1 microns to 10 microns. Wherein the glass article achieves a bend radius of 10 mm or less, and a shatter resistance defined by the capability of the glass article to avoid ejection of glass shard particles having an average aspect ratio of more than 2:1 upon bending to a failure bend radius.

In some embodiments, the glass layer according to the embodiments of either of the two preceding paragraphs is an ion exchanged glass layer having a compressive stress on at least one of the top surface and the bottom surface of the glass layer, and a concentration of metal oxide that is different at least two points through the thickness of the glass layer.

In some embodiments, the glass article according to embodiments of any of the three preceding paragraphs has an average pen drop height 3 times or more than that of a control pen drop height of the glass layer without the top and bottom polymeric coating layers.

In some embodiments, the top polymeric coating layer and the bottom polymeric coating layer according to embodiments of any of the four preceding paragraphs are solidified at a temperature of 170° C. or lower.

In some embodiments, the glass article according to embodiments of any of the five preceding paragraphs may include a polymeric optically transparent hard-coat layer disposed on the top polymeric coating layer.

In some embodiments, the glass article according to embodiments of any of the six preceding paragraphs may have a shatter resistance defined by the capability of the glass article to avoid ejection of glass shard particles having an average aspect ratio of more than 1.5:1 upon bending of to a failure bend radius.

In some embodiments, the glass article according to embodiments of any of the seven preceding paragraphs may have a shatter resistance defined by the capability of the glass article to avoid ejection of glass shard particles having an average velocity of greater than 1×10³ mm/second upon bending to a failure bend radius.

In some embodiments, the glass article according to embodiments of any of the eight preceding paragraphs may have a shatter resistance defined by the capability of the glass article of avoid ejection of glass shard particles having an average velocity of greater than 0.5×10³ mm/second upon bending to a failure bend radius.

Some embodiments are directed to an article including a cover substrate having a glass layer having a top surface, a bottom surface, and a thickness in the range of 10 microns to 200 microns, a top polymeric coating layer disposed on the top surface of the glass layer and having a thickness in the range of 0.1 microns to 10 microns, a bottom polymeric coating layer disposed on the bottom surface of the glass layer and having a thickness in the range of 0.1 microns to 10 microns. Where the glass article achieves a bend radius of 10 mm or less, an impact resistance defined by the capability of the glass article to avoid failure at an average pen drop height that is 2 times or more than that of a control pen drop height of the glass layer without the top and bottom polymeric coating layers, where the average pen drop height and the control pen drop height are measured according to a Pen Drop Test, and a shatter resistance defined by the capability of the glass article to avoid ejection of glass shard particles from the glass article upon bending to a failure bend radius.

Some embodiments are directed to an article including a cover substrate having a glass layer having a top surface, a bottom surface, and a thickness in the range of 10 microns to 200 microns, and at least one of: a top polymeric coating layer disposed on the top surface of the glass layer and having a thickness in the range of 0.1 microns to 200 microns, or a bottom polymeric coating layer disposed on the bottom surface of the glass layer and having a thickness in the range of 0.1 microns to 200 microns. Wherein the at least one of the top polymeric coating layer or the bottom polymer coating layer include an ethylene-acid copolymer and the glass article achieves a bend radius of 10 mm or less.

Some embodiments are directed to an article including a cover substrate having a glass layer having a top surface, a bottom surface, and a thickness in the range of 10 microns to 200 microns, and at least one of: a top polymeric coating layer disposed on the top surface of the glass layer and having a thickness in the range of 0.1 microns to 200 microns, or a bottom polymeric coating layer disposed on the bottom surface of the glass layer and having a thickness in the range of 0.1 microns to 200 microns. Wherein the at least one of the top polymeric coating layer or the bottom polymer coating layer including a solidified polyurethane dispersion and the glass article achieves a bend radius of 10 mm or less.

Some embodiments are directed to an article including a cover substrate having a glass layer having a top surface, a bottom surface, and a thickness in the range of 10 microns to 200 microns, and at least one of: a top polymeric coating layer disposed on the top surface of the glass layer and having a thickness in the range of 0.1 microns to 200 microns, or a bottom polymeric coating layer disposed on the bottom surface of the glass layer and having a thickness in the range of 0.1 microns to 200 microns. Wherein the at least one of the top polymeric coating layer or the bottom polymer coating layer include an acrylate resin and the glass article achieves a bend radius of 10 mm or less.

Some embodiments are directed to an article including a cover substrate having a glass layer having a top surface, a bottom surface, and a thickness in the range of 10 microns to 200 microns, and at least one of: a top polymeric coating layer disposed on the top surface of the glass layer and having a thickness in the range of 0.1 microns to 200 microns, or a bottom polymeric coating layer disposed on the bottom surface of the glass layer and having a thickness in the range of 0.1 microns to 200 microns. Wherein the at least one of the top polymeric coating layer or the bottom polymer coating layer include a mercapto-ester resin and the glass article achieves a bend radius of 10 mm or less.

Some embodiments are directed to an article including cover substrate having a glass layer having a top surface, a bottom surface, and a thickness in the range of 10 microns to 200 microns, a top polymeric coating layer disposed on the top surface of the glass layer and having a thickness in the range of 0.1 microns to 10 microns, and a bottom polymeric coating layer disposed on the bottom surface of the glass layer and having a thickness in the range of 0.1 microns to 10 microns. Wherein the glass article achieves a bend radius of 10 mm or less and a shatter resistance defined by the capability of the glass article to avoid ejection of glass shard particles having an average aspect ratio of more than 2:1 upon bending to a failure bend radius.

Some embodiments are directed to an article including a cover substrate having a glass layer having a top surface, a bottom surface, and a thickness in the range of 10 microns to 200 microns, and at least one of: a top polymeric coating layer disposed on the top surface of the glass layer and having a thickness in the range of 0.1 microns to 10 microns, or a bottom polymeric coating layer disposed on the bottom surface of the glass layer and having a thickness in the range of 0.1 microns to 10 microns. Where the glass article achieves a bend radius of 10 mm or less and a shatter resistance defined by the capability of the glass article to avoid ejection of glass shard particles having an average aspect ratio of more than 3:1 upon bending to a failure bend radius.

In some embodiments, the article according to the embodiments of any of the preceding seven paragraphs is a consumer electronic product having a housing, where the housing has a top surface, a bottom surface, side surfaces, electrical components at least partially within the housing, the electrical components having a controller, a memory and a display, where the display is at or adjacent the top surface of the housing, and where the cover substrate is disposed over the display or forms at least a portion of the housing.

In some embodiments, the glass layer according to embodiments of any of the preceding eight paragraphs is an ion exchanged glass layer having a compressive stress on at least one of the top surface and the bottom surface of the glass layer, and a concentration of metal oxide that is different at at least two points through the thickness of the glass layer.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a glass article according to some embodiments.

FIG. 2 illustrates a glass article according to some embodiments.

FIG. 3A is a graph of pen drop performances for various test samples of a glass article.

FIG. 3B is a graph of pen drop performances for various test samples of a glass article.

FIG. 4 is a graph of pen drop performances for various test samples of a glass article comprising chemically strengthened glass.

FIG. 5 illustrates a cross-sectional view of the glass article of FIG. 2 upon bending of the article.

FIG. 6A is a Weibull plot of two-point bending test results for various test samples of a glass article.

FIG. 6B is the Weibull plot of FIG. 6A with two-point bending test results for glass articles according to some embodiments reported on the plot.

FIG. 7A shows a still from a high-speed video demonstrating glass shard ejection upon bending of a glass article well beyond its design limits.

FIG. 7B shows a still from a high-speed video demonstrating glass shard ejection upon bending of a glass article well beyond its design limits.

FIG. 7C shows a still from a high-speed video demonstrating glass shard ejection upon bending of a glass article well beyond its design limits.

FIG. 8 is a table of glass shard ejection test results for various test samples of a glass article.

FIG. 9 illustrates a glass article including a coating layer according to some embodiments.

FIG. 10 illustrates a consumer product according to some embodiments.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Cover substrates for consumer products, for example cover glass, may serve to, among other things, reduce undesired reflections, prevent or reduce formation of mechanical defects in the glass (e.g., scratches or cracks), and/or provide an easy to clean transparent surface. The cover substrates disclosed herein may be incorporated into another article, for example, an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance, or a combination thereof. An exemplary article incorporating any of the glass articles disclosed herein is a consumer electronic device including a housing having top, bottom, and side surfaces; electrical components that are at least partially inside or entirely within the housing and including at least a controller, a memory, and a display at or adjacent to the top surface of the housing; and a cover substrate at or over the top surface of the housing such that it is over the display. In some embodiments, the cover substrate may include any of the glass articles disclosed herein. In some embodiments, at least one of a portion of the housing or the cover substrate comprises a glass article as disclosed herein.

Cover substrates, for example cover glasses, also serve to protect sensitive components of a consumer product from mechanical damage (e.g., puncture and impact forces). For consumer products including a flexible, foldable, and/or sharply curved portion (e.g., a flexible, foldable, and/or sharply curved display screen), a cover substrate for protecting the display screen should preserve the flexibility, foldability, and/or curvature of the screen while also protecting the screen. Moreover, the cover substrate should resist mechanical damage, for example scratches and fracturing, so that a user can enjoy an unobstructed view of the display screen.

Thick monolithic glass substrates may provide adequate mechanical properties, but these substrates can be bulky and incapable of folding to tighter radii in order to be utilized in foldable, flexible, or sharply curved consumer products. And highly flexible cover substrates, such a plastic substrates, may be unable to provide adequate puncture resistance, scratch resistance, and/or fracture resistance desirable for consumer products.

As a cover substrate, glass provides superior barrier to moisture (and oxygen) properties and hardness properties to minimize scratch and deformation damage during use. And ultra-thin glass can be bent to very small bending radii. However, glass, and particularly ultra-thin glass, may be susceptible to fracture from impact and/or puncture forces. Adding a polymeric layer to a bottom surface and/or a top surface of a glass layer may increase the impact and/or puncture resistance of the glass layer. The polymeric layer added to a bottom surface of the glass layer may increase the impact and puncture resistance without jeopardizing transparency and bendability (flexibility) of the glass. The polymeric layer added to the top and/or bottom surface may also prevent or reduce ejection of glass shard particles in the event that the glass layer fractures, as when bent beyond its designed limits, for example. In other words, the top and/or bottom polymeric layer may contain parts or particles of the glass layer in the event that the glass layer fractures.

As used herein, the terms “top surface” or “topmost surface” and “bottom surface” or “bottommost surface” reference the top and bottom surface of a layer or article as is would be oriented on a device during its normal and intended use with the top surface being the user-facing surface. For example, when incorporated into a hand-held consumer electronic product having an electronic display, the “top surface” of a glass article refers to the top surface of that article as it would be oriented when held by a user viewing the electronic display through the glass article.

Glass articles described herein include a glass layer and one or more polymeric coating layers bonded to the glass layer. The polymeric coating layer(s) not only increase puncture and impact resistance of the glass layer, but also prevent or reduce ejection of glass shard particles in the event that the glass layer fractures. By providing puncture and impact resistance, and by preventing or reducing ejection of glass shard particles, the polymeric coating(s) may reduce the number, and/or thicknesses, of coating layers to manufacture a flexible cover substrate capable of adequately protecting sensitive components of a consumer product from mechanical damage during use. Decreasing the number of coating layers may also eliminate any inflexibility added by additional layers. By preventing or reducing ejection of glass shard particles, the polymer coating layer(s) may improve shatter resistance at thicknesses significantly thinner than the glass layer, thus facilitating the flexibility of the glass article.

The polymeric coating layers discussed herein may be disposed on a surface of the glass layer (i.e., formed or deposited on the glass surface). As used herein, “disposed on” means that a first layer/component is in direct contact with a second layer/component. A first layer/component “disposed on” a second layer/component may be deposited, formed, placed, or otherwise applied directly onto the second layer/component. In other words, if a first layer/component is disposed on a second layer/component, there are no layers disposed between the first layer/component and the second layer/component. A first layer/component described as “bonded to” a second layer/component means that the layers/components are bonded to each other, either by direct contact/bonding between the two layers/components or via an adhesive layer. If a first layer (and/or component) is described as “disposed over” a second layer (and/or component), other layers may or may not be present between the first layer (and/or component) and the second layer (and/or component).

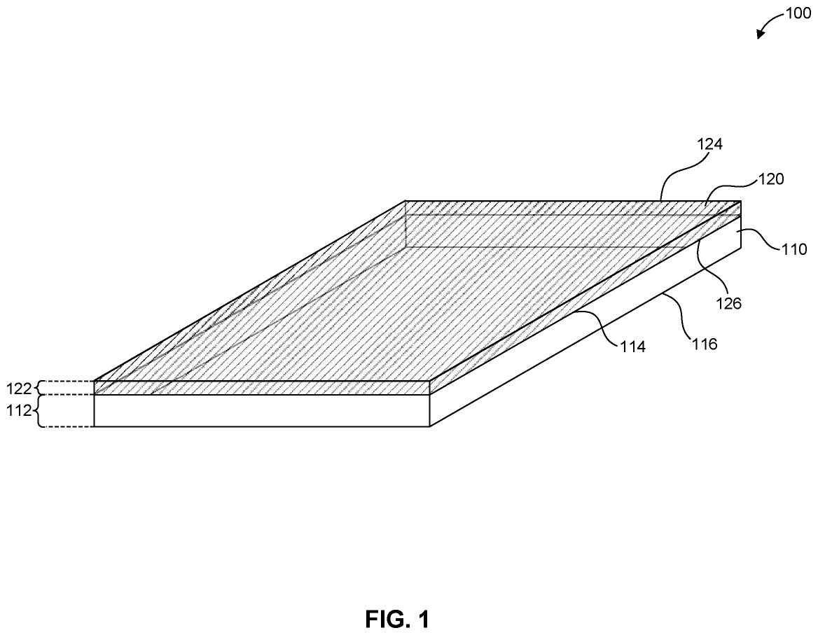

FIG. 1 illustrates a glass article 100 according to some embodiments. Glass article 100 may include a glass layer 110 and a bottom polymeric coating layer 120 disposed on a bottom surface 114 of the glass layer 110. In some embodiments, glass layer 110 may have a thickness 112, measured from a bottom surface 114 to a top surface 116 of glass layer 110, in the range of 200 microns (micrometers, μm) to 0.1 microns, including subranges. For example, glass layer 110 may have a thickness 112 of 200 microns, 175 microns, 150 microns, 125 microns, 100 microns, 90 microns, 80 microns, 75 microns, 70 microns, 60 microns, 50 microns, 40 microns, 30 microns, 25 microns, 20 microns, 10 microns, 1 micron, 0.5 microns, 0.1 microns, or within a range having any two of these values as endpoints.

In some embodiments, glass layer 110 may have a thickness 112, in the range of 125 microns to 10 microns, for example 125 microns to 20 microns, or 125 microns to 30 microns, or 125 microns to 40 microns, or 125 microns to 50 microns, or 125 microns to 60 microns, or 125 microns to 70 microns, or 125 microns to 75 microns, or 125 microns to 80 microns, or 125 microns to 90 microns, or 125 microns to 100 microns. In some embodiments, glass layer 110 may have a thickness 112 in the range of 125 microns to 15 microns, for example 120 microns to 15 microns, or 110 microns to 15 microns, or 100 microns to 15 microns, or 90 microns to 15 microns, or 80 microns to 15 microns, or 70 microns to 15 microns, or 60 microns to 15 microns, or 50 microns to 15 microns, or 40 microns to 15 microns, or 30 microns to 15 microns. In some embodiments, glass layer 110 may have a thickness within a range having any two of the values discussed in this paragraph as endpoints.

In some embodiments, glass layer 110 may be an ultra-thin glass layer. As used herein, the term “ultra-thin glass layer” means a glass layer having a thickness 112 in the range of 75 microns to 0.1 microns. In some embodiments, glass layer 110 may be a flexible glass layer. As used herein, a flexible layer or article is a layer or article capable of achieving a bend radius, by itself, of less than or equal to 10 millimeters (mm). In some embodiments, glass layer 110 may be a non-strengthened glass layer, for example a glass layer that has not been subject to an ion exchange process or a thermal tempering process. In some embodiments, glass layer 100 may have been subject to an ion exchange process. The ion exchange process results in glass layer 100 having a compressive stress on at least one of the top surface 116 and the bottom surface 114 of the glass layer, and a concentration of a metal oxide that is different at at least two points through the thickness of the glass layer. In some embodiments, glass layer 110 may be an optically transparent glass layer.

In some embodiments, bottom polymeric coating layer 120 may be bonded to glass layer 110 with an adhesive layer, for example an optically transparent adhesive. In some embodiments, bottom polymeric coating layer 120 may be disposed on (e.g., formed or deposited on) bottom surface 114 of glass layer 110. In some embodiments, bottom polymeric coating layer 120 may be an optically transparent layer.

Suitable materials for bottom polymeric coating layer 120 include, but are not limited to: ethylene-acid copolymers, for example, ethylene-acrylic acid copolymers, ethylene-methacrylic acid copolymers, and ethylene-acrylic-methacrylic acid terpolymers (e.g., Nucrel®, manufactured by DuPont), ionomers of ethylene acid copolymers (e.g., Surlyn®, manufactured by DuPont), and ethylene-acrylic acid copolymer amine dispersions (e.g., Aquacer, manufactured by BYK); polyurethane-based polymers, for example, aqueous modified polyurethane dispersions (e.g., Eleglas®, manufactured by Axalta); UV curable acrylate resins, for example, acrylate resins (e.g., Uvekol® resin, manufactured by Allnex), cyanoacrylate adhesives (e.g., Permabond® UV620, manufactured by Krayden), and UV radical acrylic resins (e.g., Ultrabond windshield repair resin, for example Ultrabond (45CPS)); and UV curable mercapto-ester based resins, for example, mercapto-ester triallyl isocyanuates (e.g., Norland optical adhesive NOA 61). In some embodiments, bottom polymeric coating layer 120 may include ethylene-acrylic acid copolymers and ethylene-methacrylic acid copolymers, which may be ionomerized to form ionomer resins through neutralization of the carboxylic acid residue, typically with alkali metal ions, for example sodium, and potassium and also zinc. Such ethylene-acrylic acid and ethylene-methacrylic acid ionomers may be dispersed within water and coated onto the substrate to form an ionomer coating. Alternatively, such acid copolymers may be neutralized with ammonia which, after coating and drying liberates the ammonia to reform the acid copolymer as the coating.

Bottom polymeric coating layer 120 may be solidified on glass article 100. In some embodiments, bottom polymeric coating layer 120 may be solidified by drying, which includes evaporating a solvent from a polymeric solution at a temperature of, for example, 170° C. or less. In some embodiments, the solvent may be water. In some embodiments, bottom polymeric coating layer 120 may be dried at room temperature (that is, about 23° C.). In some embodiments, bottom polymeric coating layer 120 may be solidified by curing. In some embodiments, curing may include introducing crosslinks to bottom polymeric coating layer 120 through exposure to a temperature, for example, 170° C. or less. In some embodiments, curing may include introducing crosslinks to bottom polymeric coating layer 120 through exposure to UV radiation.

Bottom polymeric coating layer 120 may have a thickness 122, measured from a bottom surface 124 to a top surface 126 of bottom polymeric coating layer 120, in the range of 0.1 microns to 200 microns, including subranges. For example, thickness 122 of bottom polymeric coating layer 120 may be 0.1 microns, 0.5 microns, 1 micron, 5 microns, 10 microns, 20 microns, 25 microns, 30 microns, 40 microns, 50 microns, 60 microns, 70 microns, 75 microns, 80 microns, 90 microns, 100 microns, 110 microns, 120 microns, 125 microns, 130 microns, 140 microns, 150 microns, 160 microns, 170 microns, 175 microns, 180 microns, 190 microns, 200 microns, or within a range having any two of these values as endpoints.

In some embodiments, bottom polymeric coating layer 120 may be a single monolithic layer. As used herein, “single monolithic layer” means a single integrally formed layer having a generally consistent composition across its volume. A layer that is made by layering one or more layers or materials, or by mechanically attaching different layers, is not considered a single monolithic layer.

In some embodiments, bottom surface 124 of bottom polymeric coating layer 120 may be a bottommost interior surface of glass article 100. In some embodiments, bottom surface 124 of bottom polymeric coating layer 120 may be a topmost exterior, user-facing surface of a cover substrate defined by or including glass article 100. In some embodiments, bottom surface 124 may be a topmost facing surface of bottom polymeric layer 120.

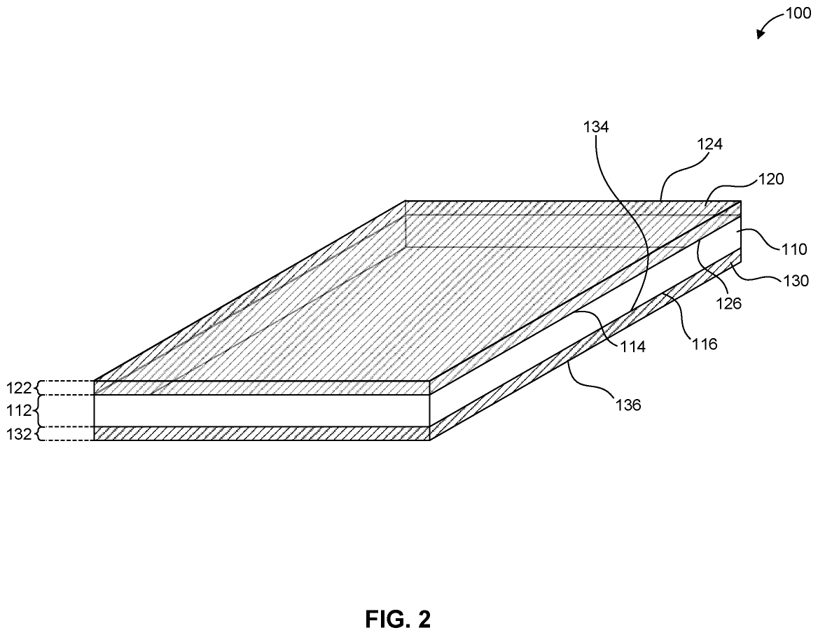

In some embodiments, as shown, for example, in FIG. 2, glass article 100 may include a top polymeric coating layer 130 disposed on a top surface 116 of the glass layer 110. In some embodiments, top polymeric coating layer 130 may be bonded to glass layer 110 with an adhesive layer, for example an optically transparent adhesive. In some embodiments, top polymeric coating layer 130 may be disposed on (e.g., formed or deposited on) top surface 116 of glass layer 110. In some embodiments, top polymeric coating layer 130 may be an optically transparent layer.

Suitable materials for top polymeric coating layer 130 include, but are not limited to: ethylene copolymers, for example, ethylene-acrylic acid copolymers, ethylene-methacrylic acid copolymers, and ethylene-acrylic-methacrylic acid terpolymers (e.g., Nucrel®, manufactured by DuPont), ionomers of ethylene acid copolymers (e.g., Surlyn®, manufactured by DuPont), and ethylene-acrylic acid copolymer amine dispersions (e.g., Aquacer, manufactured by BYK); polyurethane-based polymers, for example, aqueous modified polyurethane dispersions (e.g., Eleglas®, manufactured by Axalta); UV curable acrylate resins, for example, acrylate resins (e.g., Uvekol® resin, manufactured by Allnex), cyanoacrylate adhesives (e.g., Permabond® UV620, manufactured by Krayden), and UV radical acrylic resins (e.g., Ultrabond windshield repair resin, for example Ultrabond (45CPS)); and UV curable mercapto-ester based resins, for example, mercapto-ester triallyl isocyanuates (e.g., Norland optical adhesive NOA 61). In some embodiments, top polymeric coating layer 130 may include ethylene-acrylic acid copolymers and ethylene-methacrylic acid copolymers, which may be ionomerized to form ionomer resins through neutralization of the carboxylic acid residue with typically alkali metal ions, for example sodium, and potassium and also zinc. Such ethylene-acrylic acid and ethylene-methacrylic acid ionomers may be dispersed within water and coated onto the substrate to form an ionomer coating. Alternatively, such acid copolymers may be neutralized with ammonia which, after coating and drying liberates the ammonia to reform the acid copolymer as the coating.

Top polymeric coating layer 130 may be solidified on glass article 100. In some embodiments, top polymeric coating layer 130 may be solidified by drying, which includes evaporating a solvent from a polymeric solution at a temperature of, for example, 170° C. or less. In some embodiments, the solvent may be water. In some embodiments, top polymeric coating layer 130 may be dried at room temperature (that is, about 23° C.). In some embodiments, top polymeric coating layer 130 may be solidified by curing. In some embodiments, curing may include introducing crosslinks to top polymeric coating layer 130 through exposure to a temperature, for example, 170° C. or less. In some embodiments, curing may include introducing crosslinks to top polymeric coating layer 130 through exposure to UV radiation.

Top polymeric coating layer 130 may have a thickness 132, measured from a bottom surface 134 to a top surface 136 of top polymeric coating layer 130, in the range of 0.1 microns to 200 microns, including subranges. For example, thickness 132 of top polymeric coating layer 130 may be 0.1 microns, 0.5 microns, 1 micron, 5 microns, 10 microns, 20 microns, 30 microns, 40 microns, 50 microns, 60 microns, 70 microns, 80 microns, 90 microns, 100 microns, 110 microns, 120 microns, 125 microns, 130 microns, 140 microns, 150 microns, 160 microns, 170 microns, 175 microns, 180 microns, 190 microns, 200 microns, or within a range having any two of these values as endpoints. In some embodiments, top polymeric coating layer 130 may be a single monolithic layer.

In some embodiments, top surface 136 of top polymeric coating layer 130 may be a topmost exterior, user-facing surface of a cover substrate defined by or including glass article 100. In some embodiments, top surface 136 may be a topmost user-facing surface of top polymeric layer 130. In some embodiments, top surface 136 of top polymeric coating layer 130 may be a bottommost interior surface of glass article 100.

In some embodiments, glass article 100 may have an impact resistance defined by the capability of glass article 100 to avoid failure at a pen drop height that is “Y” times or more than that of a control pen drop height of a glass layer 110 without at least bottom polymeric coating layer 120. In some embodiments, “Y” may be 2. In some embodiments, “Y” may be 3. The pen drop height and the control pen drop height are measured according to the following “Pen Drop Test.”

As described and referred to herein, “Pen Drop Test” is conducted such that samples of glass articles are tested with the load (i.e., from a pen dropping at a certain height) imparted to a surface of a glass article with the opposite surface of the glass article bonded to a 100 micron thick layer of polyethylene terephthalate (PET) with a 50 micron thick optically transparent adhesive layer. The PTE layer in the Pen Drop Test is meant to simulate a flexible electronic display device (e.g., an OLED device). During testing, the glass article bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to the sample, and the tube is placed in contact with the top surface of the sample so that the longitudinal axis of the tube is substantially perpendicular to the top surface of the sample. The tube has an outside diameter of 2.54 cm (1 inch), an inside diameter of 1.4 cm (nine sixteenths of an inch) and a length of up to 90 cm. An acrylonitrile butadiene (“ABS”) shim is employed to hold the pen at a desired height for each test. After each drop, the tube is relocated relative to the sample to guide the pen to a different impact location on the sample. The pen employed in the Pen Drop Test is a BIC® Easy Glide Pen, Fine, having a tungsten carbide ball point tip of 0.7 mm diameter, and a weight of 5.73 grams including the cap (4.68 g without the cap). A comparable pen-like object with similar mass, aerodynamic properties, and a 0.7 mm diameter tungsten carbide ball tip may also be used.

For the Pen Drop Test, the pen is dropped with the cap attached to the top end (i.e., the end opposite the tip) so that the ball point can interact with the test sample. In a drop sequence according to the Pen Drop Test, one pen drop is conducted at an initial height of 1 cm, followed by successive drops in 1 cm increments up to 20 cm, and then after 20 cm, 2 cm increments until failure of the test sample. After each drop is conducted, the presence of any observable fracture, failure or other evidence of damage to the glass article is recorded along with the particular pen drop height. Using the Pen Drop Test, multiple samples can be tested according to the same drop sequence to generate a population with improved statistics. For the Pen Drop Test, the pen is to be changed to a new pen after every 5 drops, and for each new sample tested. In addition, all pen drops are conducted at random locations on the sample at or near the center of the sample, with no pen drops near or on the edge of the samples. For an “average pen drop height,” at least eight samples are tested according to the Pen Drop Test and the average pen drop height is reported.

For purposes of the Pen Drop Test, “failure” means the formation of a visible mechanical defect in a glass article. The mechanical defect may be a crack or plastic deformation (e.g., surface indentation). The crack may be a surface crack or a through crack. The crack may be formed on an interior or exterior surface of a glass article. The crack may extend through all or a portion of the layers of a glass article. A visible mechanical defect has minimum dimension of 0.2 millimeters or more.

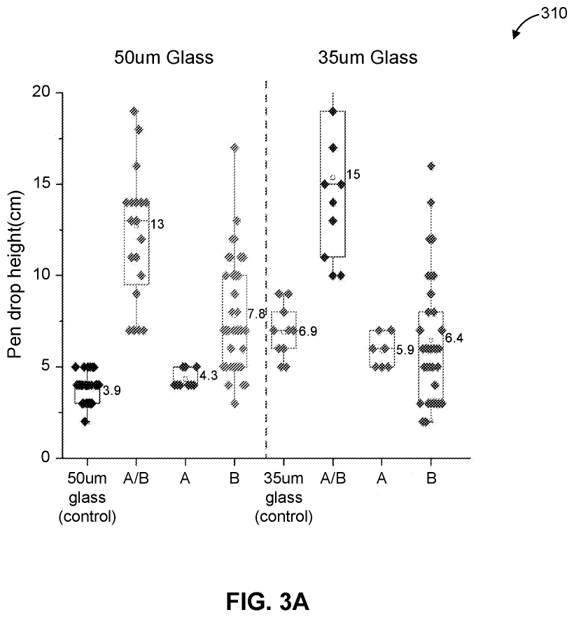

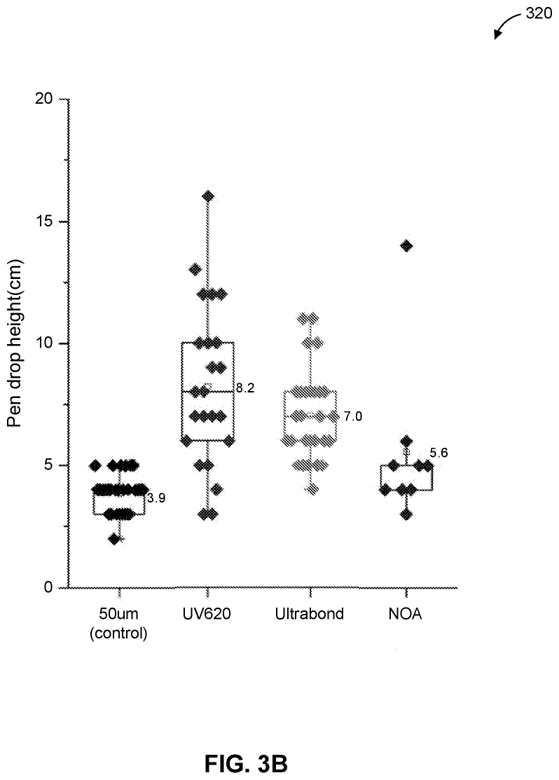

FIGS. 3A and 3B show impact test results for various samples tested with the

Pen Drop Test. For the test results shown in FIGS. 3A and 3B, a pen was dropped on the top surface of the glass article.

FIG. 3A shows a graph 310 of pen drop performance in centimeters (cm) for various test samples of glass article. Samples of the glass article included a glass layer having a thickness of 50 microns with either no polymeric coatings (control), a polymeric coating layer disposed on a top surface of the 50 micron thick glass layer (A), a polymeric coating layer disposed on a bottom surface of 50 micron thick glass layer (B), and polymeric coating layers disposed on both top and bottom surfaces of the 50 micron thick glass layer (A/B). Test samples also included a glass layer having a thickness of 35 microns with either no polymeric coatings (control), a polymeric coating layer disposed on a top surface of the 35 micron thick glass layer (A), a polymeric coating layer disposed on a bottom surface of the 35 micron thick glass layer (B), and polymeric coating layers disposed on both top and bottom surfaces of the 35 micron thick glass layer (A/B). The polymeric coating layers tested were 8 μm thick ethylene-acrylic acid copolymer coating layers prepared from an ethylene-acrylic acid copolymer amine dispersion (Aquacer, manufactured by BYK).

FIG. 3B shows a graph 320 of pen drop performance in centimeters (cm) for different test samples of a glass article. Samples of the glass article include a glass layer having a thickness of 50 microns with no polymeric coatings (control) and different polymeric coating layers disposed on a bottom surface of the glass layer. The polymeric coating layers tested included UV curable materials, and in particular, a cyanoacrylate adhesive (1 micron thick Permabond® UV620 from Krayden), a UV radical acrylic resin (1.8 micron thick Ultrabond windshield repair resin, for example Ultrabond (45CPS)), and a UV curable mercapto-ester based resins (4 micron thick Norland optical adhesive NOA 61). For each impact test, at least 8 samples of each sample type reported in FIGS. 3A and 3B were tested under the same conditions.

As shown in FIG. 3A, two different types of glass layers were tested with the Pen Drop Test: 50 micron thick glass layers and 35 micron thick glass layers. As shown by the test results in FIG. 3A, when the polymeric coating is disposed on the bottom surface, “B,” of the glass layer, the average pen-drop performance in the Pen Drop Test increases compared to the control sample. Furthermore, when the polymeric coating is disposed on both the bottom surface, “B,” and the top surface, “A,” of the glass layer, the average pen-drop performance in the Pen Drop Test increases compared to both the control sample and the sample having a polymeric coating on only the bottom surface of the glass layer. These test results show that the impact resistance for samples tested which have a polymeric coating layer on either the bottom, or top and bottom, surfaces of the glass layer are improved, exhibiting a 2 to 3 times higher pen drop height performance compared to a control. FIG. 3B shows that various different types of coatings disposed on the B side of the glass layer improved Pen Drop Test performance relative to the control glass layer having no polymeric coatings disposed thereon, exhibiting a more than 1.25 times higher pen drop height performance, a more than 1.5 times higher pen drop height performance, a more than 1.75 times higher pen drop height performance, and a more than 2 times higher pen drop height performance.

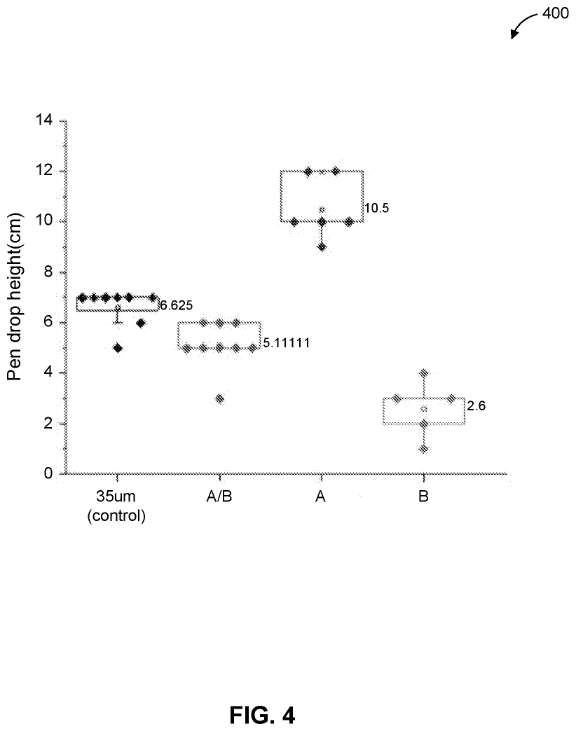

FIG. 4 shows a graph 400 of pen drop performance in centimeters (cm) for different test samples of a glass article comprising glass that had been chemically strengthened through an ion exchange process. Samples of the glass article include a chemically strengthened glass layer having a thickness of 35 microns with no polymeric coatings (control) a polymeric coating layer disposed on a top surface of the 35 micron chemically strengthened glass layer (A), a polymeric coating layer disposed on a bottom surface of the 35 micron chemically strengthened glass layer (B), and polymeric coating layers disposed on both top and bottom surfaces of the 35 micron chemically strengthened glass layer (A/B). The polymeric coating tested was an 18 μm polyurethane coating prepared from an aqueous modified polyurethane dispersion (Eleglas®, manufactured by Axalta). For each impact test, at least 8 samples of each sample type reported in FIG. 4 were tested under the same conditions.

As shown by the test results in FIG. 4, when the polymeric coating is disposed on the top surface, “A,” of the chemically strengthened glass layer, the pen-drop performance in the Pen Drop Test increases compared to the control sample. These test results show that the impact resistance for samples having a polymeric coating on a top surface of the chemically strengthened glass layer are improved, exhibiting about a 1.5 times higher pen drop height performance when compared to a control.

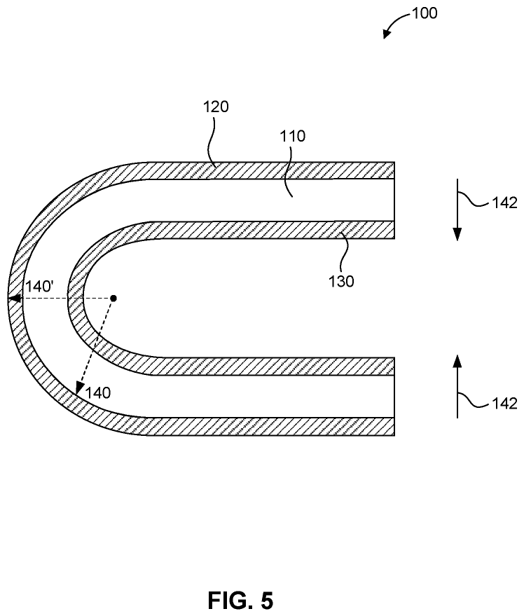

In some embodiments, for example as shown in FIG. 5, a glass article 100 may achieve a bend radius 140 of 10 mm or less. In some embodiments, glass article 100 may achieve a bend radius 140 of 9 mm or less. In some embodiments, glass article 100 may achieve a bend radius 140 of 8 mm or less. In some embodiments, glass article 100 may achieve a bend radius 140 of 7 mm or less. In some embodiments, glass article 100 may achieve a bend radius 140 of 6 mm or less. In some embodiments, glass article 100 may achieve a bend radius 140 of 5 mm or less. In some embodiments, glass article 100 may achieve a bend radius 140 of 4 mm or less. In some embodiments, glass article 100 may achieve a bend radius 140 of 3 mm or less. In some embodiments, glass article 100 may achieve a bend radius 140 of 2 mm or less. Bend radius 140 applies to glass a glass article 100 that does not have a bottom polymeric coating layer 120 disposed on a bottom surface 114.

Glass article 100 achieves a bend radius of “X,” or has a bend radius of “X,” or comprises a bend radius of “X” if it resists failure when glass article 100 is held at “X” radius for at least 240 hours at about 85° C. and about 85% relative humidity.

In embodiments including a bottom coating layer 120, for example as shown in FIG. 5, a glass article 100 may have a coated bend radius 140′ of 10 mm or less. In some embodiments, glass article 100 may have a coated bend radius 140′ of 9 mm or less. In some embodiments, glass article 100 may have a coated bend radius 140′ of 8 mm or less. In some embodiments, glass article 100 may have a coated bend radius 140′ of 7 mm or less. In some embodiments, glass article 100 may have a coated bend radius 140′ of 6 mm or less. In some embodiments, glass article 100 may have a coated bend radius 140′ of 5 mm or less. In some embodiments, glass article 100 may have a coated bend radius 140′ of 4 mm or less. In some embodiments, glass article 100 may have a coated bend radius 140′ of 3 mm or less. In some embodiments, glass article 100 may have a coated bend radius 140′ of 2 mm or less. FIG. 5 illustrates the bending force 142 applied to glass article 100 to bend it to a bend radius 140 and bend radius 140′.

Glass article 100 achieves a coated bend radius of “X,” or has a bend radius of “X,” or comprises a bend radius of “X” if it resists failure when glass article 100 is held at “X” radius for at least 240 hours at about 85° C. and about 85% relative humidity.

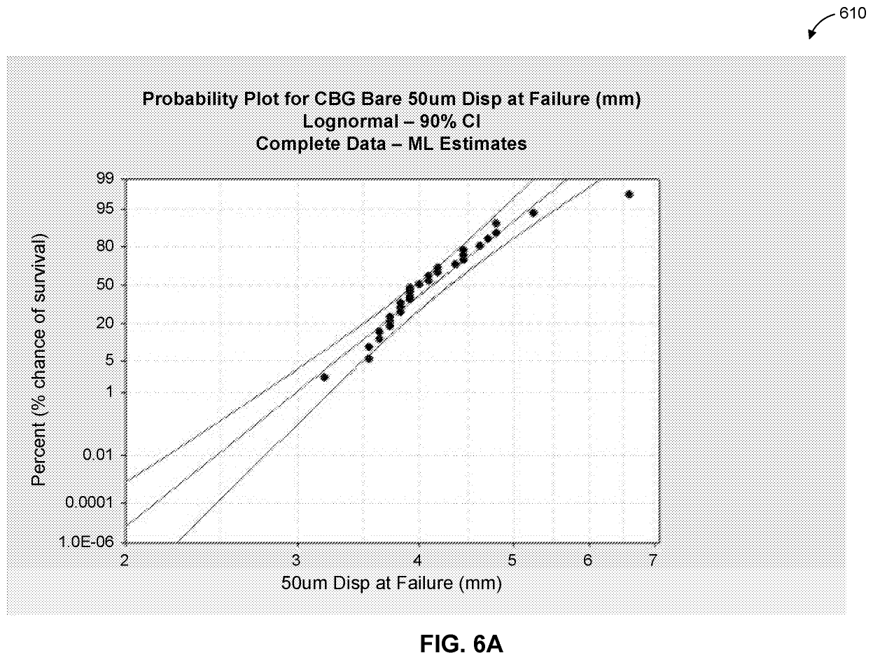

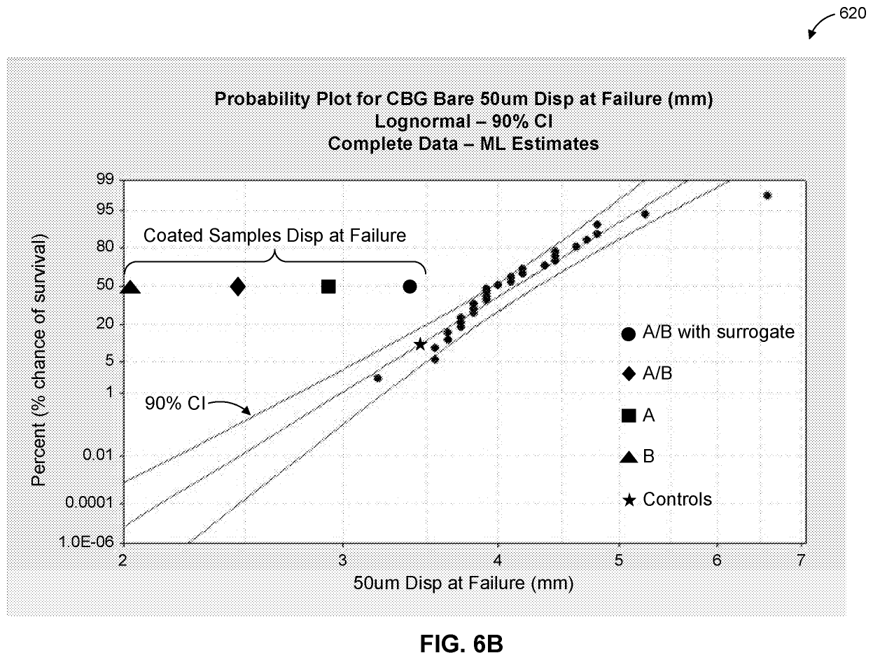

FIGS. 6A and 6B are Weibull plots 610 and 620 of two-point bending test results for various test samples of a glass article. For both plots, the glass layers/articles were bent as shown in FIG. 5 (i.e., with the top surface of the glass layer/article bent towards itself). FIG. 6A is Weibull a plot showing results from two-point bending tests of various samples of ion exchanged 50 micron thick glass layer having no polymeric coatings.

The two-point bending tests were conducted by bending the uncoated 50 micron thick samples well beyond their design limits. Samples were bent using a load frame outfitted with two plates with parallel, flat surfaces, which applied a compressive force to the samples at a constant load rate of 100 Megapascals/second (MPa/sec) until the samples fractured. High speed cameras were utilized to capture footage of the surfaces and edges of the samples as they were bending, and as they fractured. Upon fracture, the plate movement was stopped by engaging a trigger. Tests were conducted at about 25° C. and at about 50% relative humidity. FIG. 6A shows a Weibull plot demonstrating the probability that an uncoated glass layer would survive, or bend without fracture, at different plate spacings (displacements). As shown in FIG. 6A, uncoated 50 micron thick samples were predicted to have less than a 50% chance of survival at about a 4 millimeter (mm) plate spacing. The lines depicted in the plot shown in FIG. 6A are logarithmic curve fits which predict the probabilities of survival of the uncoated 50 micron thick samples as plate spacing decreased (e.g., at about 2.5 mm plate spacing, an uncoated 50 micron thick sample would have about a 0.01% probability of survival).

FIG. 6B is a plot showing the survival predictions for the uncoated 50 micron thick samples compared to actual two-point bending results for ion exchanged 50 micron thick glass layer samples having a polymeric coating layer disposed on a top surface of the glass layer (A), a polymeric coating layer disposed on a bottom surface of the glass layer (B), and polymeric coating layers disposed on both top and bottom surfaces of the glass layer (A/B). The polymeric coating layers tested were 8 μm thick ethylene-acrylic acid copolymer coating layers prepared from an ethylene-acrylic acid copolymer amine dispersion (Aquacer, manufactured by BYK).

For the control samples, uncoated bendable glass was used. For the “A” sample, the “B” sample, and one of the “A/B” samples, a 100 micron thick layer of polyethylene terephthalate (PET) was bonded to the bottom coating layer with a 50 micron thick optically transparent adhesive (OCA) layer. The second “A/B” sample did not have a PET layer (“surrogate”) bonded to it. Each reported plate displacement value is the distance between the plates minus the thickness of the PET and OCA layers (when present).

As shown in FIG. 6B, a 50 micron thick sample having a polymer coating layer disposed on a top surface, “A”, survived at a plate displacement of about 3.0 mm. Uncoated 50 micron thick samples were predicted, at a 90% confidence level (uppermost curve fit line in FIG. 6B), to have about a 4% probability of survival at this plate displacement. A 50 micron thick sample having a polymer coating layer disposed on both a top surface, “A,” and a bottom surface “B,” survived at a plate displacement of about 3.5 mm. A 50 micron thick sample having a polymer coating layer disposed on only a bottom surface, “B,” survived at a plate displacement of about 2 mm. At such plate displacements, uncoated 50 micron thick test samples were predicted, at a 90% confidence level, to have about a 20% probability of survival and a 0.001% probability of survival, respectively. The 50 micron thick glass sample having a polymer coating layer disposed on both a top surface, “A,” and a bottom surface “B,” and without the PET layer, survived at a plate displacement of about 2.45 mm. At such a plate displacement, the uncoated 50 micron thick test samples were predicted, at a 90% confidence level, to have about a 0.1% probability of survival. Accordingly, the results shown in FIG. 6B demonstrate that coating 50 micron thick glass layers coated with an ethylene-acid copolymer amine dispersion may significantly improve the flexibility of a glass article. Furthermore, the results show that 50 micron thick glass layers having a polymer coating layer disposed only on a bottom surface may demonstrate the most improved flexibility when compared to the control.

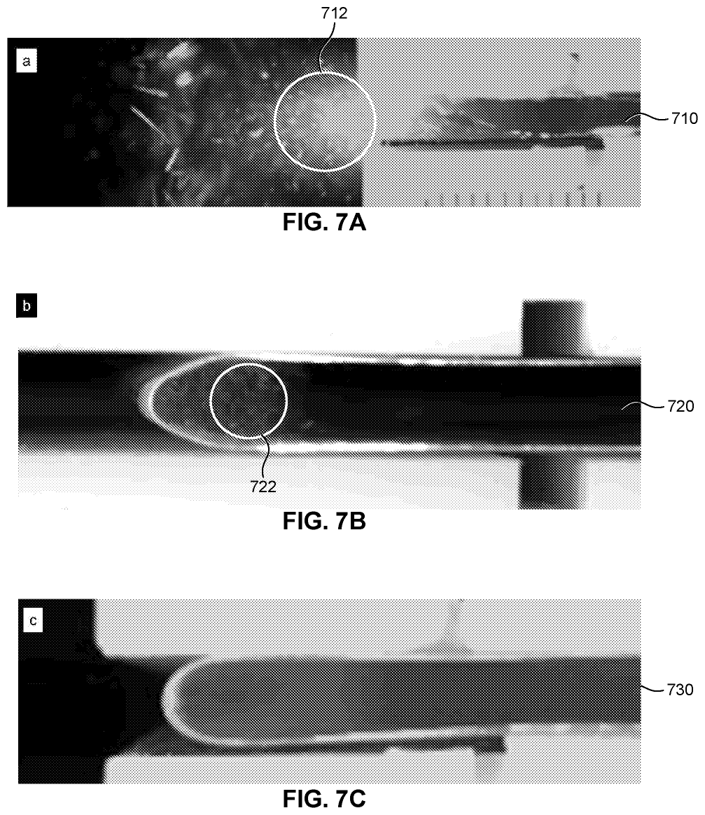

In some embodiments, for example as shown in FIGS. 7A-7C, ejection of glass shard particles may be prevented or reduced when a glass article includes, for example, a bottom polymeric coating layer disposed on a bottom surface of the glass article and a top polymeric coating layer disposed on a top surface of the glass article. FIGS. 7A-7C, for example, show stills from high-speed videos of bending of samples of the glass article to a failure bend radius, or a bend radius where the glass layer fractures. The stills show a glass article/layer being bent as shown in FIG. 5 (i.e., with the top surface of the glass layer/article bent towards itself).

FIG. 7A, for example, shows a still 710 demonstrating bending of a 50 micron bare glass sample (that is, without coating) until failure. As shown in still 710, the uncoated glass broke explosively, ejecting glass shards 712. Similarly, as shown in, for example, FIG. 7B, still 720 shows bending of a 50 micron thick glass sample with 50 micron optically clear adhesive (OCA) support on the back side of the glass. The sample in still 720 shows reduced ejection of glass shard particles 722 when compared to still 710, but glass shard particles were nevertheless ejected. Finally, as shown in, for example, FIG. 7C, still 730 shows bending of a 50 micron thick glass sample including polymeric coating layers disposed on both top and bottom surfaces of the glass sample as well as a 100 micron polyethylene terephthalate (PET) substrate bonded to the bottom polymeric coating layer with a 50 micron thick OCA. As shown in still 730, this sample demonstrated no ejection of glass shard particles upon fracture of the glass. In other words, the sample shown in still 730 demonstrated the capability to avoid ejection of glass shard particles from the glass article upon bending to a failure bend radius. In some embodiments, glass articles discussed herein may have a shatter resistance defined by the capability to avoid ejection of glass shard particles upon bending of to a failure bend radius and when no additional layers are disposed over at least one of: a top polymeric coating layer 130 or a bottom polymeric coating layer 120 of the glass article.

In some embodiments, glass article 100 may have a shatter resistance defined by the capability of glass article 100 to avoid ejection of glass shard particles having an average aspect ratio of more than “R” upon bending of to a failure bend radius. In some embodiments, “R” may be 7:1, 6:1, 5:1, 4:1, 3:1, 2:1, or 1.5:1. In some embodiments, glass article 100 may have a shatter resistance defined by the capability of glass article 100 to avoid ejection of glass shard particles having an average aspect ratio of more than 3:1. In some embodiments, glass article 100 may have a shatter resistance defined by the capability of glass article 100 to avoid ejection of glass shard particles having an average aspect ratio of more than 2:1. In some embodiments, glass article 100 may have a shatter resistance defined by the capability of glass article 100 to avoid ejection of glass shard particles having an average aspect ratio of more than 1.5:1. In some embodiments, glass article 100 may have a shatter resistance defined by the capability of glass article 100 to avoid ejection of glass shard particles having an average aspect ratio of more than “R” upon bending of to a failure bend radius and when no additional layers are disposed over at least one of: a top polymeric coating layer 130 or a bottom polymeric coating layer 120 of the glass article 100.

An aspect ratio means the ratio between the largest and smallest dimensions (d1:d2) of a glass shard particle. The three relevant dimensions for an aspect ratio are the length, width, and thickness of a glass shard. For purposes of calculating an aspect ratio, d1 is the largest of the three dimensions and d2 is the next largest of the three dimensions. An average aspect ratio of a group of glass shards may be calculated by measuring the aspect ratio of a representative number of glass shards in the group. A representative number is at least ten and, depending on the number of glass shards in the group, may be more than ten. For a group including less than ten glass shards, the aspect ratio of at least 50% of the glass shards is measured, and the measurements are averaged. The aspect ratios of the glass shard particles may be measured using a scanner.

In some embodiments, glass article 100 may have a shatter resistance defined by the capability of glass article 100 to avoid ejection of glass shard particles having an average velocity of greater than “V” millimeters per second (mm/sec) upon bending to a failure bend radius. In some embodiments, “V” may be 10×10³ mm/sec, 9×10³ mm/sec, 8×10³ mm/sec, 7×10³ mm/sec, 6×10³ mm/sec, 5×10³ mm/sec, 4×10³ mm/sec, 3×10³ mm/sec, 2×10³ mm/sec, 1×10³ mm/sec, or 0.5×10³ mm/sec. An average shard velocity may be measured by capturing high-speed video of a glass layer/article being bent beyond its designed limits and measuring the velocity of the ejected glass shards with video analysis software, for example CineView® software. Velocity as reported herein is measured within 1.5 centimeters of the concave portion of the bent article, and within the first 5000 microseconds after glass fracture. In some embodiments, glass article 100 may have a shatter resistance defined by the capability of glass article 100 to avoid ejection of glass shard particles having an average velocity of greater than “V” millimeters per second (mm/sec) upon bending to a failure bend radius and when no additional layers are disposed over at least one of: a top polymeric coating layer 130 or a bottom polymeric coating layer 120 of the glass article 100.

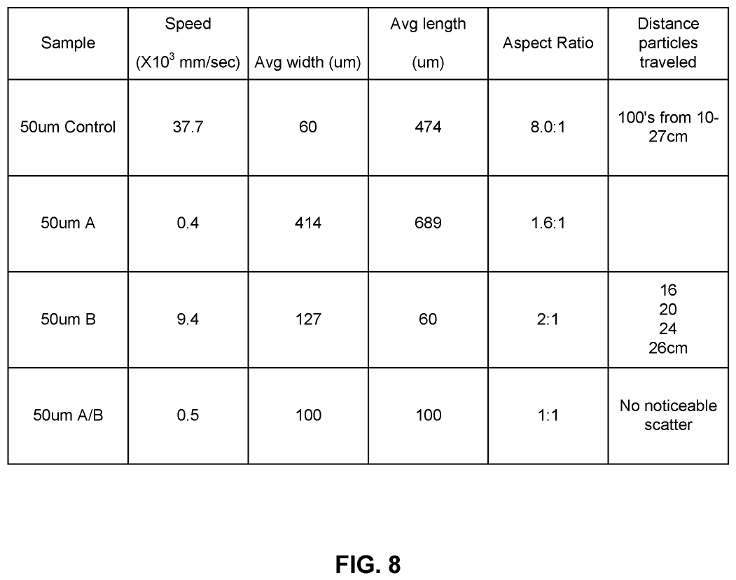

FIG. 8 shows a table of glass shard ejection test results for various test samples of a glass article having been bent to a failure bend radius, or a bend radius where the glass layer fractures when bent beyond its designed limits, as shown in, for example, FIGS. 7A-7C. Samples tested included an ion exchanged glass layer having a thickness of 50 microns with either no polymeric coatings (control), a polymeric coating layer disposed on a top surface of the 50 micron thick glass layer (A), a polymeric coating layer disposed on a bottom surface of the 50 micron thick glass layer (B), and polymeric coating layers disposed on both top and bottom surfaces of the 50 micron thick glass layer (A/B). For each sample, a 100 micron thick layer of polyethylene terephthalate (PET) was bonded to the bottom coating layer with a 50 micron thick optically transparent adhesive layer. The PET layer is meant to simulate a flexible electronic display device (e.g., an OLED device). The polymeric coating layers tested were 8 micron thick solidified ethylene-acrylic acid copolymer amine dispersions (Aquacer, manufactured by BYK). Each sample was bent as shown in FIG. 5 (i.e., with the top surface of the glass layer/article bent towards itself).

As shown in FIG. 8, when a 50 micron thick control sample was bent to a failure bend radius, glass shard particles and/or coating flakes were ejected from the top and sides of the glass article at an average speed of 37.7×10³ mm/sec. Furthermore, the particles ejected had an average aspect ratio of 8.0:1, meaning that shards were elongated and more likely to be sharp to the touch. A 50 micron thick sample having a polymer coating layer disposed on a bottom surface, “B,” showed improved shard ejection resistance, with ejection speeds about four times slower (9.4×10³mm/sec) than the control, and an average shard aspect ratio of 2:1. Additionally, samples having a polymer coating layer disposed on a top surface, “A,” and samples having a polymer coating layer on both a top surface, “A,” and a bottom surface, “B,” exhibited an even greater improvement in shard ejection resistance, when compared to the control (0.4×10³ mm/sec and 0.5×10³ mm/sec, respectively). Also, these samples ejected particles having an average aspect ratio of 1.6:1 and 1:1, respectively, and ejected mostly coating material flakes rather than glass shard particles. These aspect ratio values are significantly smaller than those for the control sample. A smaller average shard aspect ratio is desirable because it means the glass particles have more uniform shape (e.g., are more likely to be rounded), and accordingly are less likely to be sharp or jagged.

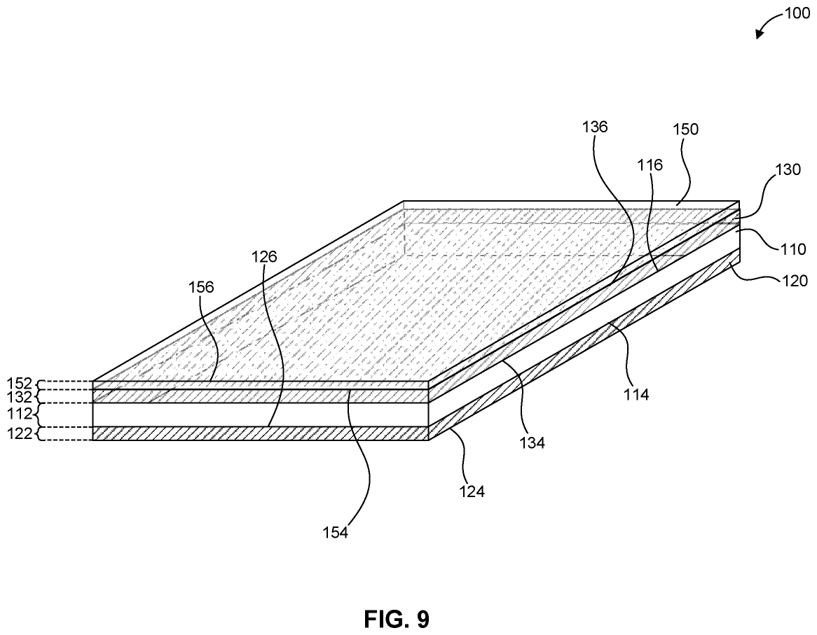

In some embodiments, for example as shown in FIG. 9, glass article 100 may be coated with a coating layer 150 having a bottom surface 154, a top surface 156, and a thickness 152. In some embodiments, a coating layer 150 may be bonded to top surface 136 of top polymeric coating layer 130 with an adhesive layer. In some embodiments, coating layer 150 may disposed on top surface 136 of top polymeric coating layer 130. In some embodiments, multiple coating layers 150, of the same or different types, may be coated on a glass article 100.

In some embodiments, a coating layer 150 may be an inorganic optically transparent hard-coat layer, for example a silicon dioxide (SiO₂) or aluminum oxide (Al₂O₃) layer deposited by a physical vapor deposition process, a chemical vapor deposition process or an atomic layer deposition process. In some embodiments, a coating layer 150 may be an optically transparent polymeric (OTP) hard-coat layer. An inorganic or OTP hard-coat layer 150 may have a pencil hardness of, for example, 7H, 8H, or 9H. As used herein, “optically transparent” means an average transmittance of 70% or more in the wavelength range of 400 nm to 700 nm through a 1.0 mm thick piece of a material. In some embodiments, an optically transparent material may have an average transmittance of 75% or more, 80% or more, 85% or more, or 90% or more in the wavelength range of 400 nm to 700 nm through a 1.0 mm thick piece of the material. The average transmittance in the wavelength range of 400 nm to 700 nm is calculated by measuring the transmittance of all whole number wavelengths from 400 nm to 700 nm and averaging the measurements.

Suitable materials for an OTP hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In some embodiments, an OTP hard-coat layer may consist essentially of an organic polymer material, an inorganic-organic hybrid polymeric material, or aliphatic or aromatic hexafunctional urethane acrylate. In some embodiments, an OTP hard-coat layer may consist of a polyimide, an organic polymer material, an inorganic-organic hybrid polymeric material, or aliphatic or aromatic hexafunctional urethane acrylate. In some embodiments, an OTP hard-coat layer may include a nanocomposite material. In some embodiments, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto.

As used herein, “organic polymer material” means a polymeric material comprising monomers with only organic components. In some embodiments, an OTP hard-coat layer may comprise an organic polymer material manufactured by Gunze Limited and having a hardness of 9H, for example Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example inorganic particulate dispersed within an organic matrix.

In some embodiments, the inorganic-organic hybrid polymeric material may include polymerized monomers comprising an inorganic silicon-based group, for example, a silsesquioxane polymer. A silsesquioxane polymer may be, for example, an alky-silsesquioxane, an aryl-silsesquioxane, or an aryl alkyl-silsesquioxane having the following chemical structure: (RSiO_{1.5})n, where R is an organic group for example, but not limited to, methyl or phenyl. In some embodiments, an OTP hard-coat layer may comprise a silsesquioxane polymer combined with an organic matrix, for example, SILPLUS manufactured by Nippon Steel Chemical Co., Ltd.

In some embodiments, an OTP hard-coat layer may comprise 90 wt % to 95 wt % aromatic hexafunctional urethane acrylate (e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8 H or more. In some embodiments, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate.

An OTP hard-coat layer may have a thickness 152 in the range of 10 microns to 120 microns, including subranges. For example, an OTP hard-coat layer may have a thickness 186 of 10 microns, 20 microns, 30 microns, 40 microns, 50 microns, 60 microns, 70 microns, 80 microns, 90 microns, 100 microns, 110 microns, 120 microns, or within a range having any two of these values as endpoints. In some embodiments, an OTP hard-coat layer may be a single monolithic layer.

In some embodiments, an OTP hard-coat layer may be an inorganic-organic hybrid polymeric material layer or an organic polymer material layer having a thickness in the range of 80 microns to 120 microns, including subranges. For example, an OTP hard-coat layer comprising an inorganic-organic hybrid polymeric material or an organic polymer material may have a thickness of 80 microns, 90 microns, 100 microns, 110 microns, 120 microns, or within a range having any two of these values as end points. In some embodiments, an OTP hard-coat layer may be an aliphatic or aromatic hexafunctional urethane acrylate material layer having a thickness in the range of 10 microns to 60 microns, including subranges. For example, an OTP hard-coat layer comprising an aliphatic or aromatic hexafunctional urethane acrylate material may have a thickness of 10 microns, 20 microns, 30 microns, 40 microns, 50 microns, 60 microns, or within a range having any two of these values as end points.

In some embodiments, coating layer(s) 150 may be an anti-reflection coating layer. Exemplary materials suitable for use in the anti-reflection coating layer include: SiO₂, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, and other materials cited above as suitable for use in a scratch resistant layer. An anti-reflection coating layer may include sub-layers of different materials.

In some embodiments, the anti-reflection coating layer may include a hexagonally packed nanoparticle layer, for example but not limited to, the hexagonally packed nanoparticle layers described in U.S. Pat. No. 9,272,947, issued Mar. 1, 2016, which is hereby incorporated by reference in its entirety by reference thereto. In some embodiments, the anti-reflection coating layer may include a nanoporous Si-containing coating layer, for example but not limited to the nanoporous Si-containing coating layers described in WO2013/106629, published on Jul. 18, 2013, which is hereby incorporated by reference in its entirety by reference thereto. In some embodiments, the anti-reflection coating may include a multilayer coating, for example, but not limited to the multilayer coatings described in WO2013/106638, published on Jul. 18, 2013; WO2013/082488, published on Jun. 6, 2013; and U.S. Pat. No. 9,335,444, issued on May 10, 2016, all of which are hereby incorporated by reference in their entirety by reference thereto.

In some embodiments, coating layer(s) 150 may be an easy-to-clean coating layer. In some embodiments, the easy-to-clean coating layer may include a material selected from the group consisting of fluoroalkylsilanes, perfluoropolyether alkoxy silanes, perfluoroalkyl alkoxy silanes, fluoroalkylsilane-(non-fluoroalkylsilane) copolymers, and mixtures of fluoroalkylsilanes. In some embodiments, the easy-to-clean coating layer may include one or more materials that are silanes of selected types containing perfluorinated groups, for example, perfluoroalkyl silanes of formula (R_{F})_{y}Si_{X4-y}, where RF is a linear C6-C₃₀ perfluoroalkyl group, X=CI, acetoxy, —OCH₃, and —OCH₂CH₃, and y=2 or 3. The perfluoroalkyl silanes can be obtained commercially from many vendors including Dow-Corning (for example fluorocarbons 2604 and 2634), 3MCompany (for example ECC-1000 and ECC-4000), and other fluorocarbon suppliers, for example Daikin Corporation, Ceko (South Korea), Cotec-GmbH (DURALON UltraTec materials) and Evonik. In some embodiments, the easy-to-clean coating layer may include an easy-to-clean coating layer as described in WO2013/082477, published on Jun. 6, 2013, which is hereby incorporated by reference in its entirety by reference thereto.

In some embodiments, coating layer(s) 150 may be an anti-glare layer formed on top surface 136 of top polymeric coating layer 130. Suitable anti-glare layers include, but are not limited to, the anti-glare layers prepared by the processes described in U.S. Pat. Pub. Nos. 2010/0246016, 2011/0062849, 2011/0267697, 2011/0267698, 2015/0198752, and 2012/0281292, all of which are hereby incorporated by reference in their entirety by reference thereto.

In some embodiments, coating layer(s) 150 may be an anti-fingerprint coating layer. Suitable anti-fingerprint coating layers include, but are not limited to, oleophobic surface layers including gas-trapping features, as described in, for example, U.S. Pat. App. Pub. No. 2011/0206903, published Aug. 25, 2011, and oleophilic coatings formed from an uncured or partially-cured siloxane coating precursor comprising an inorganic side chain that is reactive with the surface of the glass or glass-ceramic substrate (e.g., partially-cured linear alkyl siloxane), as described in, for example, U.S. Pat. App. Pub. No. 2013/0130004, published May 23, 2013. The contents of U.S. Pat. App. Pub. No. 2011/0206903 and U.S. Pat. App. Pub. No. 2013/0130004 are incorporated herein by reference in their entirety.

In some embodiments, coating layer(s) 150 may be an anti-microbial and/or anti-viral layer may be formed on top surface 136 of top polymeric coating layer 130. Suitable anti-microbial and/or anti-viral layers include, but are not limited to, an antimicrobial Ag+region extending from the surface of the glass article to a depth in the glass article having a suitable concentration of Ag+1 ions on the surface of the glass article, as described in, for example, U.S. Pat. App. Pub. No. 2012/0034435, published Feb. 9, 2012, and U.S. Pat. App. Pub. No. 2015/0118276, published Apr. 30, 2015. The contents of U.S. Pat. App. Pub. No. 2012/0034435 and U.S. Pat. App. Pub. No. 2015/0118276 are incorporated herein by reference in their entirety.

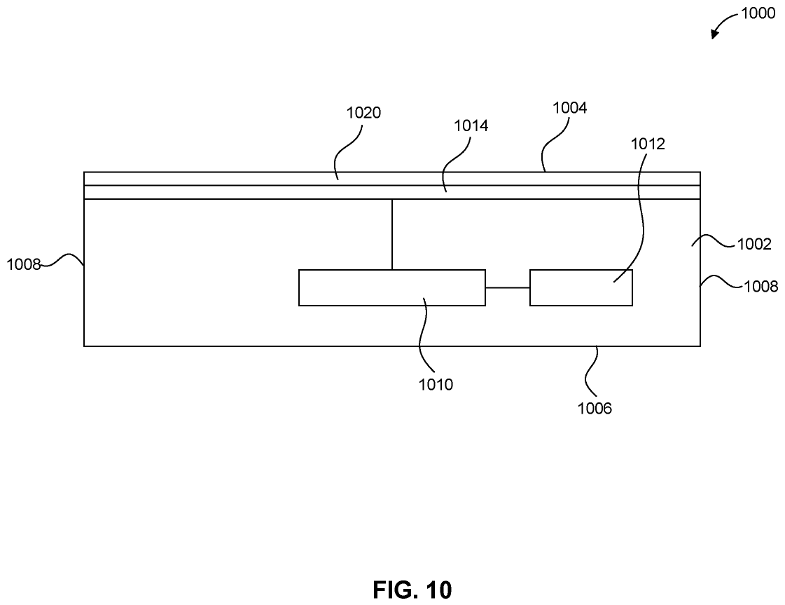

FIG. 10 shows a consumer electronic product 1000 according to some embodiments. Consumer electronic product 1000 may include a housing 1002 having a top (user-facing) surface 1004, a bottom surface 1006, and side surfaces 1008. Electrical components may be at least partially within housing 1002. The electrical components may include, among others, a controller 1010, a memory 1012, and display components, including a display 1014. In some embodiments, display 1014 may be at or adjacent to top surface 1004 of housing 1002. Display 1014 may be, for example, a light emitting diode (LED) display or an organic light emitting diode (OLED) display.

As shown for example in FIG. 10, consumer electronic product 1000 may include a cover substrate 1020. Cover substrate 1020 may serve to protect display 1014 and other components of electronic product 1000 (e.g., controller 1010 and memory 1012) from damage. In some embodiments, cover substrate 1020 may be disposed over display 1014. In some embodiments, cover substrate 1020 may be bonded to display 1014. In some embodiments, cover substrate 1020 may be a cover glass defined in whole or in part by a glass article discussed herein. Cover substrate 1020 may be a 2D, 2.5D, or 3D cover substrate. In some embodiments, cover substrate 920 may define top surface 1004 of housing 1002. In some embodiments, cover substrate 1020 may define top surface 1004 of housing 1002 and all or a portion of side surfaces 1008 of housing 1002. In some embodiments, consumer electronic product 1000 may include a cover substrate defining all or a portion of bottom surface 1006 of housing 1002.

As used herein the term “glass” is meant to include any material made at least partially of glass, including glass and glass-ceramics. “Glass-ceramics” include materials produced through controlled crystallization of glass. In embodiments, glass-ceramics have about 30% to about 90% crystallinity. Non-limiting examples of glass ceramic systems that may be used include Li₂O×Al₂O₃×nSiO₂ (i.e. LAS system), MgO×Al₂O₃×nSiO₂ (i.e. MAS system), and ZnO×Al₂O₃×nSiO₂ (i.e. ZAS system).

In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may either include lithia or be free of lithia. In one or more alternative embodiments, the substrate may include crystalline substrates, for example glass ceramic substrates (which may be strengthened or non-strengthened) or may include a single crystal structure, for example sapphire. In one or more specific embodiments, the substrate includes an amorphous base (e.g., glass) and a crystalline cladding (e.g., sapphire layer, a polycrystalline alumina layer and/or or a spinel (MgAl₂O₄) layer).

In some embodiments, the glass composition for glass layers discussed herein may include 40 mol % to 90 mol % SiO₂ (silicon oxide). In some embodiments, the glass composition may include 40 mol %, 45 mol %, 50 mol %, 55 mol %, 60 mol %, 65 mol %, 70 mol %, 75 mol %, 80 mol %, 85 mol %, or 90 mol % SiO₂, or a mol % within any range having any two of these values as end points. In some embodiments, the glass composition may include 55 mol % to 70 mol % SiO₂. In some embodiments, the glass composition may include 57.43 mol % to 68.95 mol % SiO₂.

In some embodiments, the glass composition for glass layers discussed herein may include 1 mol % to 10 mol % B₂O₃ (boron oxide). In some embodiments, the glass composition may include 1 mol %, 2 mol %, 3 mol %, 4 mol %, 5 mol %, 6 mol % ,7 mol %, 8 mol %, 9 mol %, or 10 mol % B₂O₃, or a mol % within any range having any two of these values as end points. In some embodiments, the glass composition may include 3 mol % to 6 mol % B₂O₃. In some embodiments, the glass composition may include 3.86 mol % to 5.11 mol % B₂O₃. In some embodiments, the glass composition may not include B₂O₃.

In some embodiments, the glass composition for glass layers discussed herein may include 5 mol % to 30 mol % Al₂O₃ (aluminum oxide). In some embodiments, the glass composition may include 5 mol %, 10 mol %, 15 mol %, 20 mol %, 25 mol %, or 30 mol % Al₂O₃, or a mol % within any range having any two of these values as end points. In some embodiments, the glass composition may include 10 mol % to 20 mol % Al₂O₃. In some embodiments, the glass composition may include 10.27 mol % to 16.10 mol % Al₂O₃.

In some embodiments, the glass composition for glass layers discussed herein may include 1 mol % to 10 mol % P₂O₅ (phosphorus oxide). In some embodiments, the glass composition may include 1 mol %, 2 mol %, 3 mol %, 4 mol %, 5 mol %, 6 mol %, 7 mol %, 8 mol %, 9 mol %, or 10 mol % P₂O₅, or a mol % within any range having any two of these values as end points. In some embodiments, the glass composition may include 2 mol % to 7 mol % P₂O₅. In some embodiments, the glass composition may include 2.47 mol % to 6.54 mol % P₂O₅. In some embodiments, the glass composition may not include P₂O₅.

In some embodiments, the glass composition for glass layers discussed herein may include 5 mol % to 30 mol % Na₂O (sodium oxide). In some embodiments, the glass composition may include 5 mol %, 10 mol %, 15 mol %, 20 mol %, 25 mol %, or 30 mol % Na₂O , or a mol % within any range having any two of these values as end points. In some embodiments, the glass composition may include 10 mol % to 20 mol % Na₂O . In some embodiments, the glass composition may include 10.82 mol % to 17.05 mol % Na₂O .

In some embodiments, the glass composition for glass layers discussed herein may include 0.01 mol % to 0.05 mol % K₂O (potassium oxide). In some embodiments, the glass composition may include 0.01 mol %, 0.02 mol %, 0.03 mol %, 0.04 mol %, or 0.05 mol % K₂O, or a mol % within any range having any two of these values as end points. In some embodiments, the glass composition may include 0.01 mol % K₂O. In some embodiments, the glass composition may not include K₂O.

In some embodiments, the glass composition for glass layers discussed herein may include 1 mol % to 10 mol % MgO (magnesium oxide). In some embodiments, the glass composition may include 1 mol %, 2 mol %, 3 mol %, 4 mol %, 5 mol %, 6 mol %, 7 mol %, 8 mol %, 9 mol %, or 10 mol % MgO, or a mol % within any range having any two of these values as end points. In some embodiments, the glass composition may include 2 mol % to 6 mol % MgO. In some embodiments, the glass composition may include 2.33 mol % to 5.36 mol % MgO. In some embodiments, the glass composition may not include MgO.

In some embodiments, the glass composition for glass layers discussed herein may include 0.01 mol % to 0.1 mol % CaO (calcium oxide). In some embodiments, the glass composition may include 0.01 mol %, 0.02 mol %, 0.03 mol %, 0.04 mol %, 0.05 mol %, 0.06 mol %, 0.07 mol %, 0.08 mol %, 0.09 mol %, or 0.1 mol % CaO, or a mol % within any range having any two of these values as end points. In some embodiments, the glass composition may include 0.03 mol % to 0.06 mol % CaO. In some embodiments, the glass composition may not include CaO.

In some embodiments, the glass composition for glass layers discussed herein may include 0.01 mol % to 0.05 mol % Fe₂O₃ (iron oxide). In some embodiments, the glass composition may include 0.01 mol %, 0.02 mol %, 0.03 mol %, 0.04 mol %, or 0.05 mol % Fe₂O₃ , or a mol % within any range having any two of these values as end points. In some embodiments, the glass composition may include 0.01 mol % Fe₂O₃ . In some embodiments, the glass composition may not include Fe₂O₃ .

In some embodiments, the glass composition for glass layers discussed herein may include 0.5 mol % to 2 mol % ZnO (zinc oxide). In some embodiments, the glass composition may include 0.5 mol %, 1 mol %, 1.5 mol %, or 2 mol % ZnO, or a mol % within any range having any two of these values as end points. In some embodiments, the glass composition may include 1.16 mol % ZnO. In some embodiments, the glass composition may not include ZnO.

In some embodiments, the glass composition for glass layers discussed herein may include 1 mol % to 10 mol % Li₂O (lithium oxide). In some embodiments, the glass composition may include 1 mol %, 2 mol %, 3 mol %, 4 mol %, 5 mol %, 6 mol %, 7 mol %, 8 mol %, 9 mol %, or 10 mol % Li₂O, or a mol % within any range having any two of these values as end points. In some embodiments, the glass composition may include 5 mol % to 7 mol % Li₂O. In some embodiments, the glass composition may include 6.19 mol % Li₂O. In some embodiments, the glass composition may not include Li₂O.

In some embodiments, the glass composition for glass layers discussed herein may include 0.01 mol % to 0.3 mol % SnO₂ (tin oxide). In some embodiments, the glass composition may include 0.01 mol %, 0.05 mol %, 0.1 mol %, 0.15 mol %, 0.2 mol %, 0.25 mol %, or 0.3 mol %, SnO₂, or a mol % within any range having any two of these values as end points. In some embodiments, the glass composition may include 0.01 mol % to 0.2 mol % SnO₂. In some embodiments, the glass composition may include 0.04 mol % to 0.17 mol % SnO₂.

In some embodiments, the glass composition for glass layers discussed herein may be a composition including a value for R₂O (alkali metal oxide(s))+RO (alkali earth metal oxide(s)) in the range of 10 mol % to 30 mol %. In some embodiments, R₂O+RO may be 10 mol %, 15 mol %, 20 mol %, 25 mol %, or 30 mol %, or a mol % within any range having any two of these values as end points. In some embodiments, R₂O+RO may be in the range of 15 mol % to 25 mol %. In some embodiments, R₂O+RO may be in the range of 16.01 mol % to 20.61 mol %.

A substrate or layer may be strengthened to form a strengthened substrate or layer. As used herein, the terms “strengthened substrate” or “strengthened layer” may refer to a substrate/layer that has been chemically strengthened, for example through ion exchange of larger ions for smaller ions in the surface of the substrate/layer. Other strengthening methods known in the art, for example thermal tempering, or utilizing a mismatch of the coefficient of thermal expansion between portions of the substrate/layer to create compressive stress and central tension regions, may also be utilized to form strengthened substrates/layers.

Where the substrate/layer is chemically strengthened by an ion exchange process, the ions in the surface layer of the substrate/layer are replaced by—or exchanged with—larger ions having the same valence or oxidation state. Ion exchange processes are typically carried out by immersing a substrate/layer in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate/layer in a salt bath (or baths), use of multiple salt baths, additional steps, for example annealing, washing, and the like, are generally determined by the composition of the substrate/layer and the desired compressive stress (CS), depth of compressive stress layer (or depth of layer) of the substrate that result from the strengthening operation. By way of example, ion exchange of alkali metal-containing glass substrates/layers may be achieved by immersion in at least one molten bath containing a salt for example, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates/layers are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath is diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The term “or,” as used herein, is inclusive; more specifically, the phrase “A or B” means “A, B, or both A and B.” Exclusive “or” is designated herein by terms such as “either A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

The term “wherein” is used as an open-ended transitional phrase, to introduce a recitation of a series of characteristics of the structure.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, for example within about 5% of each other, or within about 2% of each other.

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents. For example, the various features of the disclosure may be combined according to the following example embodiments.

Embodiment 1. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymeric coating layer comprise an ethylene-acid copolymer, and
   wherein the glass article achieves a bend radius of 10 mm or less.

Embodiment 2. The glass article of Embodiment 1, wherein the glass layer is an ion exchanged glass layer comprising a compressive stress on at least one of the top surface and the bottom surface of the glass layer, and a concentration of metal oxide that is different at least two points through the thickness of the glass layer.

Embodiment 3. The glass article of Embodiment 1, wherein the glass article comprises the top polymeric coating layer.

Embodiment 4. The glass article of Embodiment 3, wherein the thickness of the top polymeric coating layer is in the range of 0.1 microns to 10 microns.

Embodiment 5. The glass article of Embodiment 1, wherein the glass article comprises the bottom polymeric coating layer.

Embodiment 6. The glass article of Embodiment 5, wherein the thickness of the bottom polymeric coating layer is in the range of 0.1 microns to 10 microns.

Embodiment 7. The glass article of Embodiment 1, wherein the glass article comprises the top polymeric coating layer and the bottom polymeric coating layer.

Embodiment 8. The glass article of Embodiment 7, wherein the thickness of the top polymeric coating layer is in the range of 0.1 microns to 10 microns and wherein the thickness of the bottom polymeric coating layer is in the range of 0.1 microns to 10 microns.

Embodiment 9. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymeric coating layer comprise a solidified polyurethane dispersion, and
   wherein the glass article achieves a bend radius of 10 mm or less.

Embodiment 10. The glass article of Embodiment 9, wherein the glass layer is an ion exchanged glass layer comprising a compressive stress on at least one of the top surface and the bottom surface of the glass layer, and a concentration of metal oxide that is different at least two points through the thickness of the glass layer.

Embodiment 11. The glass article of Embodiment 9, wherein the glass article comprises the top polymeric coating layer.

Embodiment 12. The glass article of Embodiment 11, wherein the thickness of the top polymeric coating layer is in the range of 0.1 microns to 10 microns.

Embodiment 13. The glass article of Embodiment 9, wherein the glass article comprises the bottom polymeric coating layer.

Embodiment 14. The glass article of Embodiment 13, wherein the thickness of the bottom polymeric coating layer is in the range of 0.1 microns to 10 microns.

Embodiment 15. The glass article of Embodiment 9, wherein the glass article comprises the top polymeric coating layer and the bottom polymeric coating layer.

Embodiment 16. The glass article of Embodiment 15, wherein the thickness of the top polymeric coating layer is in the range of 0.1 microns to 10 microns and wherein the thickness of the bottom polymeric coating layer is in the range of 0.1 microns to 10 microns.

Embodiment 17. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymeric coating layer comprise an acrylate resin, and
   wherein the glass article achieves a bend radius of 10 mm or less.

Embodiment 18. The glass article of Embodiment 17, wherein the glass layer is an ion exchanged glass layer comprising a compressive stress on at least one of the top surface and the bottom surface of the glass layer, and a concentration of metal oxide that is different at at least two points through the thickness of the glass layer.

Embodiment 19. The glass article of Embodiment 17, wherein the glass article comprises the top polymeric coating layer.

Embodiment 20. The glass article of Embodiment 19, wherein the thickness of the top polymeric coating layer is in the range of 0.1 microns to 10 microns.

Embodiment 21. The glass article of Embodiment 17, wherein the glass article comprises the bottom polymeric coating layer.

Embodiment 22. The glass article of Embodiment 21, wherein the thickness of the bottom polymeric coating layer is in the range of 0.1 microns to 10 microns.

Embodiment 23. The glass article of Embodiment 17, wherein the glass article comprises the top polymeric coating layer and the bottom polymeric coating layer.

Embodiment 24. The glass article of Embodiment 23, wherein the thickness of the top polymeric coating layer is in the range of 0.1 microns to 10 microns and wherein the thickness of the bottom polymeric coating layer is in the range of 0.1 microns to 10 microns.

Embodiment 25. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymeric coating layer comprises a mercapto-ester resin, and
   wherein the glass article achieves a bend radius of 10 mm or less.

Embodiment 26. The glass article of Embodiment 25, wherein the glass layer is an ion exchanged glass layer comprising a compressive stress on at least one of the top surface and the bottom surface of the glass layer, and a concentration of metal oxide that is different at least two points through the thickness of the glass layer.

Embodiment 27. The glass article of Embodiment 25, wherein the glass article comprises the top polymeric coating layer.

Embodiment 28. The glass article of Embodiment 27, wherein the thickness of the top polymeric coating layer is in the range of 0.1 microns to 10 microns.

Embodiment 29. The glass article of Embodiment 25, wherein the glass article comprises the bottom polymeric coating layer.

Embodiment 30. The glass article of Embodiment 29, wherein the thickness of the bottom polymeric coating layer is in the range of 0.1 microns to 10 microns.

Embodiment 31. The glass article of Embodiment 25, wherein the glass article comprises the top polymeric coating layer and the bottom polymeric coating layer.

Embodiment 32. The glass article of Embodiment 31, wherein the thickness of the top polymeric coating layer is in the range of 0.1 microns to 10 microns and wherein the thickness of the bottom polymeric coating layer is in the range of 0.1 microns to 10 microns.

Embodiment 33. A glass article, comprising:
a glass layer comprising a top surface, a bottom surface, and a thickness in the range of 10 microns to 200 microns;
a top polymeric coating layer disposed on the top surface of the glass layer and comprising a thickness in the range of 0.1 microns to 10 microns; and
a bottom polymeric coating layer disposed on the bottom surface of the glass layer and comprising a thickness in the range of 0.1 microns to 10 microns,
   wherein the glass article achieves a bend radius of 10 mm or less,
   wherein the glass article comprises an impact resistance defined by the capability of the glass article to avoid failure at an average pen drop height that is 2 times or more than that of a control pen drop height of the glass layer without the top and bottom polymeric coating layers, wherein the average pen drop height and the control pen drop height are measured according to a Pen Drop Test, and wherein the glass article comprises a shatter resistance defined by the capability of the glass article to avoid ejection of glass shard particles from the glass article upon bending to a failure bend radius.

Embodiment 34. The glass article of Embodiment 33, wherein the glass layer is an ion exchanged glass layer comprising a compressive stress on at least one of the top surface and the bottom surface of the glass layer, and a concentration of metal oxide that is different at at least two points through the thickness of the glass layer.

Embodiment 35. The glass article of Embodiment 33 or Embodiment 34, wherein the top polymeric coating layer and the bottom polymeric coating layer are solidified at a temperature of 170° C. or lower.

Embodiment 36. The glass article of any one of Embodiments 33-35, further comprising a polymeric optically transparent hard-coat layer disposed on the top polymeric coating layer.

Embodiment 37. The glass article of any one of Embodiments 33-36, wherein the average pen drop height is 3 times or more than that of a control pen drop height of the glass layer without the top and bottom polymeric coating layers.

Embodiment 38. An article comprising:
a cover substrate comprising:
a glass layer comprising a top surface, a bottom surface, and a thickness in the range of 10 microns to 200 microns;
a top polymeric coating layer disposed on the top surface of the glass layer and comprising a thickness in the range of 0.1 microns to 10 microns; and
a bottom polymeric coating layer disposed on the bottom surface of the glass layer and comprising a thickness in the range of 0.1 microns to 10 microns,
   wherein the glass article achieves a bend radius of 10 mm or less,
   wherein the glass article comprises an impact resistance defined by the capability of the glass article to avoid failure at an average pen drop height that is 2 times or more than that of a control pen drop height of the glass layer without the top and bottom polymeric coating layers, wherein the average pen drop height and the control pen drop height are measured according to a Pen Drop Test, and
   wherein the glass article comprises a shatter resistance defined by the capability of the glass article to avoid ejection of glass shard particles from the glass article upon bending to a failure bend radius.

Embodiment 39. The article of Embodiment 38, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 40. The article of Embodiment 38, wherein the glass layer is an ion exchanged glass layer comprising a compressive stress on at least one of the top surface and the bottom surface of the glass layer, and a concentration of metal oxide that is different at least two points through the thickness of the glass layer.

Embodiment 41. A glass article, comprising:
a glass layer comprising a top surface, a bottom surface, and a thickness in the range of 10 microns to 200 microns;
a top polymeric coating layer disposed on the top surface of the glass layer and comprising a thickness in the range of 0.1 microns to 10 microns; and
a bottom polymeric coating layer disposed on the bottom surface of the glass layer and comprising a thickness in the range of 0.1 microns to 10 microns,
   wherein the glass article achieves a bend radius of 10 mm or less, and
   wherein the glass article comprises a shatter resistance defined by the capability of the glass article to avoid ejection of glass shard particles having an average aspect ratio of more than 2:1 upon bending to a failure bend radius.

Embodiment 42. The glass article of Embodiment 41, wherein the glass article comprises a shatter resistance defined by the capability of the glass article to avoid ejection of glass shard particles having an average aspect ratio of more than 1.5:1 upon bending of to a failure bend radius.

Embodiment 43. The glass article of Embodiment 41, wherein the glass article comprises a shatter resistance defined by the capability of the glass article to avoid ejection of glass shard particles having an average velocity of greater than 1×10³ mm/second upon bending to a failure bend radius.

Embodiment 44. The glass article of Embodiment 41, wherein the glass article comprises a shatter resistance defined by the capability of the glass article of avoid ejection of glass shard particles having an average velocity of greater than 0.5×10³ mm/second upon bending to a failure bend radius.

Embodiment 45. The article of any one of Embodiments 41-44, wherein the glass layer is an ion exchanged glass layer comprising a compressive stress on at least one of the top surface and the bottom surface of the glass layer, and a concentration of metal oxide that is different at at least two points through the thickness of the glass layer.

Embodiment 46. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 10 microns, or a bottom polymeric coating layer disposed on the bottom surface of the glass layer and comprising a thickness in the range of 0.1 microns to 10 microns,
   wherein the glass article achieves a bend radius of 10 mm or less, and
   wherein the glass article comprises a shatter resistance defined by the capability of the glass article to avoid ejection of glass shard particles having an average aspect ratio of more than 3:1 upon bending to a failure bend radius.

Embodiment 47. The glass article of Embodiment 46, wherein the glass article comprises a shatter resistance defined by the capability of the glass article to avoid ejection of glass shard particles having an average aspect ratio of more than 2:1 upon bending of to a failure bend radius.

Embodiment 48. The glass article of Embodiment 46, wherein the glass article comprises a shatter resistance defined by the capability of the glass article of avoid ejection of glass shard particles having an average velocity of greater than 10×10³ mm/second upon bending to a failure bend radius.

Embodiment 49. The glass article of Embodiment 46, wherein the glass article comprises a shatter resistance defined by the capability of the glass article to avoid ejection of glass shard particles having an average velocity of greater than 1×10³ mm/second upon bending to a failure bend radius.

Embodiment 50. The glass article of any one of Embodiments 46-49, wherein the glass layer is an ion exchanged glass layer comprising a compressive stress on at least one of the top surface and the bottom surface of the glass layer, and a concentration of metal oxide that is different at at least two points through the thickness of the glass layer.

Embodiment 51. An article comprising:
a cover substrate comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymer coating layer comprise an ethylene-acid copolymer, and
   wherein the glass article achieves a bend radius of 10 mm or less.

Embodiment 52. The article of Embodiment 51, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 53. An article comprising:
a cover substrate comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymer coating layer comprise a solidified polyurethane dispersion, and
   wherein the glass article achieves a bend radius of 10 mm or less.

Embodiment 54. The article of Embodiment 53, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 55. An article comprising:
a cover substrate comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymer coating layer comprise an acrylate resin, and
   wherein the glass article achieves a bend radius of 10 mm or less.

Embodiment 56. The article of Embodiment 55, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 57. An article comprising:
a cover substrate comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
   wherein the at least one of the top polymeric coating layer or the bottom polymer coating layer comprise a mercapto-ester resin, and
   wherein the glass article achieves a bend radius of 10 mm or less.

Embodiment 58. The article of Embodiment 57, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 59. An article comprising:
a cover substrate comprising:
a glass layer comprising a top surface, a bottom surface, and a thickness in the range of 10 microns to 200 microns;
a top polymeric coating layer disposed on the top surface of the glass layer and comprising a thickness in the range of 0.1 microns to 10 microns; and
a bottom polymeric coating layer disposed on the bottom surface of the glass layer and comprising a thickness in the range of 0.1 microns to 10 microns,
wherein the glass article achieves a bend radius of 10 mm or less, and
wherein the glass article comprises a shatter resistance defined by the capability of the glass article to avoid ejection of glass shard particles having an average aspect ratio of more than 2:1 upon bending to a failure bend radius.

Embodiment 60. The article of Embodiment 59, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

Embodiment 61. An article comprising:
a cover substrate comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 10 microns, or a bottom polymeric coating layer disposed on the bottom surface of the glass layer and comprising a thickness in the range of 0.1 microns to 10 microns,
   wherein the glass article achieves a bend radius of 10 mm or less, and
   wherein the glass article comprises a shatter resistance defined by the capability of the glass article to avoid ejection of glass shard particles having an average aspect ratio of more than 3:1 upon bending to a failure bend radius.

Embodiment 62. The article of Embodiment 61, wherein the article is a consumer electronic product, the consumer electronic product comprising:
a housing comprising a top surface, a bottom surface, and side surfaces;
electrical components at least partially within the housing, the electrical components comprising a controller, a memory, and a display, the display at or adjacent the top surface of the housing; and
the cover substrate, wherein the cover substrate is disposed over the display or forms at least a portion of the housing.

1. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 200 microns, or a bottom polymeric coating layer disposed on the bottom surface of the glass layer and comprising a thickness in the range of 0.1 microns to 200 microns,
wherein the at least one of the top polymeric coating layer or the bottom polymeric coating layer comprise one of: an ethylene-acid copolymer; a solidified polyurethane dispersion; an acrylate resin; or a mercapto-ester resin; and
wherein the glass article achieves a bend radius of 10 mm or less.

2. The glass article of claim 1, wherein the glass layer is an ion exchanged glass layer comprising a compressive stress on at least one of the top surface and the bottom surface of the glass layer, and a concentration of metal oxide that is different at least two points through the thickness of the glass layer.

3. The glass article of claim 1, wherein the glass article comprises the top polymeric coating layer and the bottom polymeric coating layer.

4. A glass article, comprising:
a glass layer comprising a top surface, a bottom surface, and a thickness in the range of 10 microns to 200 microns;
a top polymeric coating layer disposed on the top surface of the glass layer and comprising a thickness in the range of 0.1 microns to 10 microns; and
a bottom polymeric coating layer disposed on the bottom surface of the glass layer and comprising a thickness in the range of 0.1 microns to 10 microns,
wherein the glass article achieves a bend radius of 10 mm or less,
wherein the glass article comprises an impact resistance defined by the capability of the glass article to avoid failure at an average pen drop height that is 2 times or more than that of a control pen drop height of the glass layer without the top and bottom polymeric coating layers, wherein the average pen drop height and the control pen drop height are measured according to a Pen Drop Test, and
wherein the glass article comprises a shatter resistance defined by the capability of the glass article to avoid ejection of glass shard particles from the glass article upon bending to a failure bend radius.

5. The glass article of claim 4, wherein the glass layer is an ion exchanged glass layer comprising a compressive stress on at least one of the top surface and the bottom surface of the glass layer, and a concentration of metal oxide that is different at least two points through the thickness of the glass layer.

6. The glass article of claim 4, wherein the top polymeric coating layer and the bottom polymeric coating layer are solidified at a temperature of 170° C. or lower.

7. The glass article of claim 4, further comprising a polymeric optically transparent hard-coat layer disposed on the top polymeric coating layer.

8-10. (canceled)

11. A glass article, comprising:
a glass layer comprising a top surface, a bottom surface, and a thickness in the range of 10 microns to 200 microns; and
at least one of: a top polymeric coating layer disposed on the top surface of the glass layer and comprising a thickness in the range of 0.1 microns to 10 microns, or a bottom polymeric coating layer disposed on the bottom surface of the glass layer and comprising a thickness in the range of 0.1 microns to 10 microns,
wherein the glass article achieves a bend radius of 10 mm or less, and
wherein the glass article comprises a shatter resistance defined by the capability of the glass article to avoid ejection of glass shard particles having an average aspect ratio of more than 3:1 upon bending to a failure bend radius.

12. The glass article of claim 11, wherein the glass article comprises a shatter resistance defined by the capability of the glass article to avoid ejection of glass shard particles having an average velocity of greater than 1×10³ mm/second upon bending to a failure bend radius.

13. The glass article of claim 11, wherein the glass layer is an ion exchanged glass layer comprising a compressive stress on at least one of the top surface and the bottom surface of the glass layer, and a concentration of metal oxide that is different at least two points through the thickness of the glass layer.

14. The glass article of claim 11, further comprising both the top polymeric coating layer and the bottom polymeric coating layer,
wherein the glass article achieves a bend radius of 10 mm or less, and
wherein the glass article comprises a shatter resistance defined by the capability of the glass article to avoid ejection of glass shard particles having an average aspect ratio of more than 2:1 upon bending to a failure bend radius.

15. The glass article of claim 14, wherein the glass article comprises a shatter resistance defined by the capability of the glass article of avoid ejection of glass shard particles having an average velocity of greater than 0.5×10³ mm/second upon bending to a failure bend radius.
